(19) United States
(12) Patent Application Publication
(10) Pub. No.: US 2013/0018960 A1
(43) Pub. Date: Jan. 17, 2013

(54) Group Interaction around Common Online Content

(71) Applicants: Matthew S. Knysz, Fremont, MI (US); Daniel Starin, Rockville, MD (US); Christian Bendixen, New York, NY (US)

(72) Inventors: Matthew S. Knysz, Fremont, MI (US); Daniel Starin, Rockville, MD (US); Christian Bendixen, New York, NY (US)

(73) Assignee: SURFARI INC., Rockville, MD (US)

(21) Appl. No.: 13/550,380

(22) Filed: Jul. 16, 2012

Related U.S. Application Data
(60) Provisional application No. 61/507,884, filed on Jul. 14, 2011.

(51) Int. Cl. G06F 15/16

(52) U.S. Cl. 709/204

(57) ABSTRACT

An on-line system that allows a group of people to interact around common content, in which the system includes: a computer network; a server system coupled to the computer network; and multiple user devices, each of which is coupled to the computer network and each of which is associated with a respective member of the group, in which the server system stores identification information for each member of the group, and in which, in response to receiving a lead to content initiated by a member of the group, the server system is configured to send a reference to the content to the respective user devices of the other members of the group. In response to receiving the reference to the content, at least some of the user devices automatically access and load the content via the network.

### CLAIM OF PRIORITY

This application claims the benefit of U.S. Provisional Patent Application Ser. No. 61/507,884, filed on Jul. 14, 2011.

### BACKGROUND

In general, social networking applications provide users with a means for communicating and interacting over networks, such as the Internet. In some cases, users are required to register with the social networking applications, after which the user can establish a personal profile, send messages to other users, and post content for others to view.

### SUMMARY

The present disclosure relates to group interaction around common online content.

In general, an innovative aspect of the subject matter described in this specification can be embodied in an on-line system that allows a group of people to interact around common content, in which the system includes: a computer network; a server system coupled to the computer network; and multiple user devices, each of which is coupled to the computer network and each of which is associated with a respective member of the group, in which the server system stores identification information for each member of the group, and in which, in response to receiving a lead to content initiated by a member of the group, the server system is configured to send a reference to the content to the respective user devices of the other members of the group, and in which, in response to receiving the reference to the content, at least some of the user devices automatically access and load the content via the network.

Other implementations of this aspect include corresponding apparatus, and computer program products encoded on computer-readable media, each operable to cause a data processing apparatus to perform the actions of the server system. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The foregoing and other implementations can each optionally include one or more of the following features, alone or in combination. For example, the content can be selected from the group consisting of a video file, a document file, an image file, an audio file, a webpage and combinations thereof. In response to receiving the lead to the content, the server system can be configured to cause at least some of the user devices to each access and load the content beginning at the same portion of the content. In response to receiving a seek command from a first user device, the system can be configured to cause one or more other user devices to each access the content beginning at the same portion that is currently being accessed by the first user device. In response to receiving a synchronize command from a first user device, the server system can be configured to cause the first user device to access the content beginning at the same portion that is being accessed by another user device.

In some implementations, in response to receiving a related content request issued by a first user device, the server system can be configured to provide to the first user device a collection of different content, in which the collection of different content is selected based on a feature of the referenced content.

In some implementations, in response to receiving the reference to the content, at least some of the user devices can automatically access and load individually accessible and identical versions of the content via the network. In some cases, in response to receiving an invite initiated by a first user device from the multiple user devices, the server system can send an invite message to one or more user devices not associated with a member of the group. In certain implementations, the identification information for each member of the group can include individual member identification information and group identification information.

In some implementations, the server system can be configured to store content in a playlist queue accessible by each of the user devices, and cause at least some of the user devices to sequentially access and load the stored content. The group of people can correspond to a first group that is a subset of a second larger group, in which the system, in response to receiving the lead to content initiated by the member of the first group, can be configured to send the reference to the content to one or more user devices associated with members of the second group, and in which, in response to receiving the reference to the content, the one or more user devices associated with members of the second group can automatically access and load the content via the network.

In some implementations, the reference to content includes information about the identity of the member that initiated the lead to content. In response to receiving the reference to content, at least some of the user devices can be configured to display the information about the identity of the member that initiated the lead to content.

In some implementations, the at least some user devices automatically access and load the content within a page of an Internet browser. The server system can be configured to receive data from a first user device and relay the data in real-time to the respective user devices of the other members of the group, in which the user devices, upon receiving the data, cause the data to be displayed within the page of the Internet browser.

In some implementations, the server system can be configured to: store a history of content accessed by the multiple user devices; and send the history to the respective user devices of the members of the group.

In some implementations, the group of people corresponds to a first group, in which the system, in response to receiving a lead to a second group, sends a reference to the second group to one or more user devices associated with members of the first group, and in which the lead to the second group is issued by the member of the first group.

In some implementations, the content includes multiple different content items, in which one or more of the user devices concurrently load and access at least some of the different content items in response to receiving the reference to the content.

In some implementations, the reference to the content includes a reference to multiple different content items.

In some implementations, at least one of the user devices is configured to broadcast over the network identification information for the group and information about a location of the at least one user device.

Another innovative aspect of the subject matter described in this specification can be embodied in machine-implemented methods of allowing a group of people to interact around common content, in which the methods include the actions of: receiving, at a server device, a lead to content from a first user device associated with a member of the group; sending from the server device, over a network, a reference to the content to one or more respective second user devices of other members of the group, in which the reference to the content includes instructions to cause each second user device, upon receiving the reference to the content, to automatically access and load the content via the network.

Other implementations of this aspect include corresponding computer systems, apparatus, and computer program products encoded on computer-readable media, each operable to cause a data processing apparatus to perform the actions of the methods. The foregoing and other implementations can each optionally include one or more of the following features, alone or in combination. For example, the content can be selected from the group consisting of a video file, a document file, an image file, an audio file, a webpage and combinations thereof.

The reference to the content can include instructions to cause each second user device, upon receiving the reference to the content, to access and load the content beginning at the same portion of the content.

In some implementations, the methods can further include the actions of: receiving, at the server device, a seek request from the first user device; and sending to each second user device, in response to receiving the seek request, instructions to cause the second user device to access the content beginning at the same portion that is currently being accessed by the first user device.

In some implementations, the methods can further include the actions of receiving, at the server device, a synchronize request from the first user device; and sending to the first user device, in response to receiving the synchronize request, instructions to cause the first user device to access the content beginning at the same portion that is currently being accessed by at least one of the second user devices. The methods can further include the actions of obtaining state information about the content being accessed by the at least one second user device prior to sending the instructions to cause the first user device to access the content beginning at the same portion that is currently being accessed by at least one of the second user devices.

In some implementations, the methods can further include the actions of receiving, at the server device, a related content request from the first user device; and sending to the first user device a collection of different content, in which the collection of different content is selected based on a feature of the referenced content.

In some implementations, the methods further include the actions of storing at the server device identification information for each member of the group. The identification information can include individual member identification information and group identification information.

In some implementations, the methods further can include the actions of storing content in a playlist queue accessible by the first user device and the second user devices.

In some cases, the group of people corresponds to a first group that is a subset of a second larger group, in which the methods can further include the actions of sending from the server device, over the network, the reference to the content to at least one third user device of a member of the second group.

In some implementations, the reference to the content can include information about the identity of the member that initiated the lead to content.

Another innovative aspect of the subject matter described in this specification can be embodied in an on-line system that allows a group of people to interact around common content, in which the system includes: a computer network; a server system coupled to the computer network; and multiple user devices, each of which is coupled to the computer network and each of which is associated with a respective member of the group, in which the server system stores identification information for each member of the group, and in which, in response to receiving a lead to content initiated by a member of the group, the server system is configured to send a reference that includes a link to the content to the respective user devices of the other members of the group. The server system can be configured to cause at least some of the user devices to each access and load the content beginning at the same portion of the content upon selection of the link.

The details of one or more implementations are set forth in the accompanying drawings and the description below. Other aspects, features and advantages of the subject matter disclosed herein will be apparent from the description, the drawings, and the claims.

### BRIEF DESCRIPTION OF DRAWINGS

FIG. 1 is a schematic of an example system that enables the formation of groups for collaborating around common content over a network.

FIG. 2 is a schematic of an example of a system architecture that enables the formation of groups for collaborating around common content over a network.

FIG. 3 is a process flow diagram that shows an example of an authentication procedure using the system architecture shown in FIG. 2.

FIG. 4 is a process flow diagram that shows an example of a procedure using the system architecture shown in FIG. 2.

FIG. 5 is a process flow diagram that shows an example of a procedure using the system architecture shown in FIG. 2.

FIG. 6 is a process flow diagram that shows an example of a procedure using the system architecture shown in FIG. 2.

FIG. 7 is a schematic diagram of an example of an alternative system architecture.

FIG. 8 is a schematic diagram of an example of an alternative system architecture.

FIG. 9 is a schematic diagram of an example of an alternative system architecture.

FIG. 10 is a schematic diagram of multiple client devices that belong to a collaboration group.

FIG. 11 is an example of a screenshot of a group webpage.

FIG. 12 is an example of a screen shot of an alternative design for a collaboration group webpage.

FIG. 13 is an example of a screen shot of an alternative version of the collaboration group webpage.

FIG. 14 is an example of a screen shot of the version of the collaboration group webpage shown in FIG. 13.

FIG. 15 is an example of a screen shot in which a user has selected a thumbnail to preview.

FIGS. 16-30 are examples of screen shots of collaboration group webpages.

FIG. 31 is a schematic diagram depicting how content can include other groups.

FIG. 32 is a schematic diagram that shows an abstraction of how one group could spawn multiple child related groups.

FIG. 33 is a schematic that depicts an abstraction of how a private group relates to a parent group from which the private group was created.

### DETAILED DESCRIPTION

The present disclosure relates to a system that enables the formation of groups that can collaborate around common content over a network. Content is understood as data accessible through the use of a computing device and includes, for example, video or audio feeds (live or recorded), documents, webpages and images. Individual access to the content can be restricted to users in a single group or be made available to users across multiple specified groups. In addition, the system can enable users within a group to interact with one or more other users within the same group while simultaneously providing individual access to the content. Methods of interaction can include, for example, real-time instant messaging between users, group chats, and group video conferencing, among other techniques. Regardless of the content and method of interaction, users of the system can also provide leads to content, in which the content is viewable by all members within a group.

As used herein, bootstrap address is the address or URL of a collaboration group.

As used herein, a lead is a message sent within a collaboration group that provides members within the group access or direction to particular content.

As used herein, seek is a special lead indicating a position (e.g., time or location) of content. Seek can reference a temporal component of content (such as a particular time in a video file or audio file), or a positional component of content (such as a particular position in a document file or webpage or a particular slide of a presentation file).

As used herein, Same Origin Policy (“SOP”), is a web security policy that prohibits one domain from reading content from another domain without the second domain's explicit consent.

As used here, a client device is a device using the collaboration group service. The device may be associated with a particular user (i.e., person).

As used herein, common content is content available to authorized members of a group.

As used herein, a user ID is a unique identifier within a collaboration group system that represents an individual user.

As used herein, a GroupID is a unique identifier with a collaboration group system that represents a particular collaboration group.

As used herein, “real-time,” in the context of data processing, means without intentional delay, given the processing limitations of the system used to perform the data processing.

I. System Overview

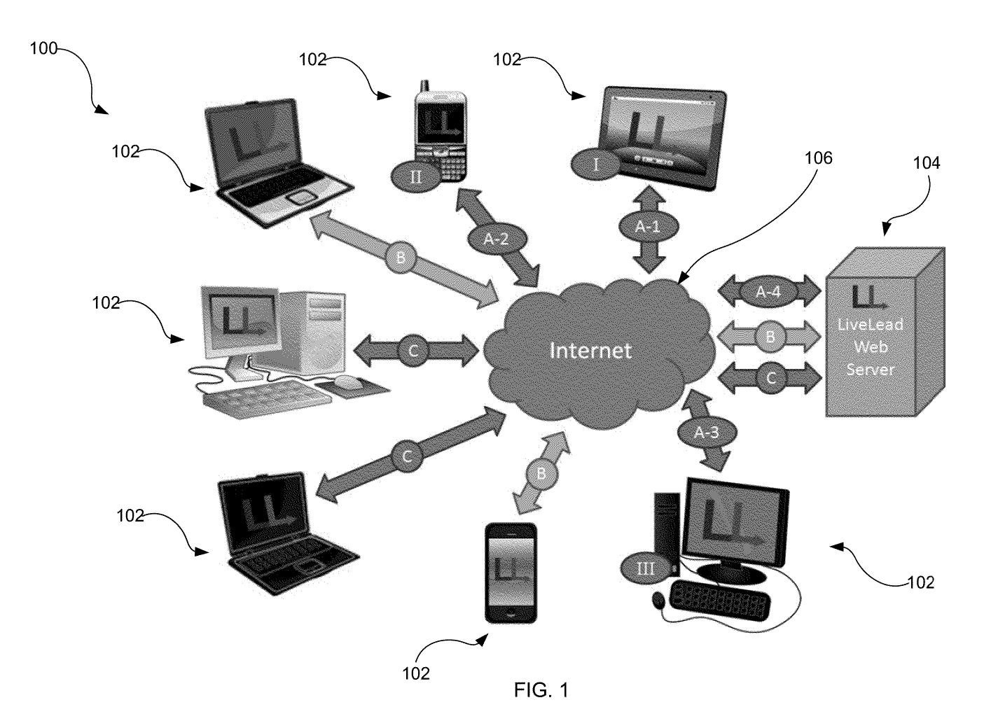

FIG. 1 is a schematic of an example system 100 that enables the formation of groups for collaborating around common content over a network. The system 100 includes one or more client devices 102 and one or more application server devices 104, in which the devices 102, 104 are coupled to one or another over a network 106. The network 106 can include any suitable collection of computing devices and other hardware components interconnected by communication channels (wired or wireless) that allow sharing of resources and information and includes networks such as, for example, local area networks, wide area networks, and aggregated networks (e.g., the Internet), among others. The client devices 102 can include various different types of computing devices including, but not limited to, mobile phones, smart phones, laptop computers, desktop personal computers, tablets, and personal digital assistants. The one or more server devices 104 can correspond to any suitable computing device on which a computing application may run and on which data can be stored.

The double sided arrows in FIG. 1 represent data transmission to and/or from client devices 102 and the server device 104. The different letters (A, B, C) represent different corresponding “collaboration groups” to which a client device 102 can belong. A collaboration group includes one or more client devices 102, in which individual and simultaneous access to the same content can be provided to each client device 102 within the group. Each collaboration group can be associated with a unique identification parameter (e.g., a “GroupID”).

Various different devices can join a collaboration group. For example, group A includes three different client devices 102, all having different hardware and running different operating systems: a tablet (labeled “I”), a smart phone (labeled “II”), and a desktop computer (labeled “III”). Yet, all three heterogeneous devices 102 can participate in a single collaboration group (i.e., group A). Furthermore, any of the members of a collaboration group can make content available to other devices in the group. For example, the tablet (labeled “I”) can issue a message (a “lead”) to other devices 102 in the group, in which the lead includes a reference (e.g., a hyperlink) to particular content. The lead is sent over the network (“A-1”) and reaches the application server 104 (“A-4”). The application server 104 then informs the other members of the group (A) about the lead and which group member sent it. This information is sent from the application server 104 back into the Internet (“A-4”) where it is routed to all of group A's group members: the smart phone “II” is informed via “A-2” and the desktop via “A-3”. The lead message (and its accompanying information, such as the issuer of the lead) is not sent to other devices 102 that are not a part of Group “A”. Each client device 102 is associated with a particular group based on information provided by the user operating the device. For example, a client device 102 can be associated with a particular group when a user selects the group to join and provides authorization information that is subsequently verified.

Collaboration

The collaboration technique described herein differs from screen sharing in that the collaboration technique passes references to content, not the content itself. Users operating client devices 102 establish separate sessions with the referenced content, thus allowing groups to scale with the content provider. In an example scenario, a member of a particular group provides to other members in the group a reference to content such as a form containing a number of data entry fields (e.g., a webpage for purchasing plane tickets). Although it may make sense for different users to browse the document at the same time, it may not make sense for each member of the group to share/make available the information (e.g., social security number, credit card information, etc.) that each user enters into the form. Thus, the present system 100 enables users within a group to simultaneously access the same content together, while also having their own personal instances of the shared content.

In contrast, with respect to screen sharing, members of a group sharing a particular screen can only access the portions of the content that is currently being accessed by an individual user in the group (e.g., the group leader). For example, when viewing a shared webpage, members other than the group leader are unable to scroll to different desired sections of the webpage to view content. Rather, the members are limited to viewing sections of the webpage that the group leader happens to currently be viewing. This is similar to watching the group leader browse the web by looking over the group leader's shoulder at the computer screen. Other group members can see what the group leader sees, but have no way to influence the content without asking the group leader to do so.

Group collaboration, however, enables each member of a group to access their own individual version of common content. For example, a group member can provide a content lead (e.g., a reference to a webpage) to other members of the group, in which the lead causes the group members' content devices to access the content, such that each group member's individual client device 102 loads the content. Alternatively, the lead can include a link (e.g., hyperlink) to the content. In this way, all group members access the same content (e.g., the same webpage), but the group members are also all accessing individual versions of the content, using their own client devices 102. Thus, for example, if a webpage contains certain authentication requirements, and some of the group members don't meet these requirements, then the group members that fail to meet the requirements will be unable to view the webpage in the same way as those group members who do meet the authentication requirements. Groups established by the system 100 also allow real-time communication between users within groups, through programs such as instant messaging, chat groups, and live video conferencing. Accordingly, group members can both access individual versions of the same content while interacting with other members simultaneously.

Whether a lead automatically causes a group member's client device to access the content or contains a link to content can be set individually (e.g., based on user preference) or as a property of the group.

System Architecture

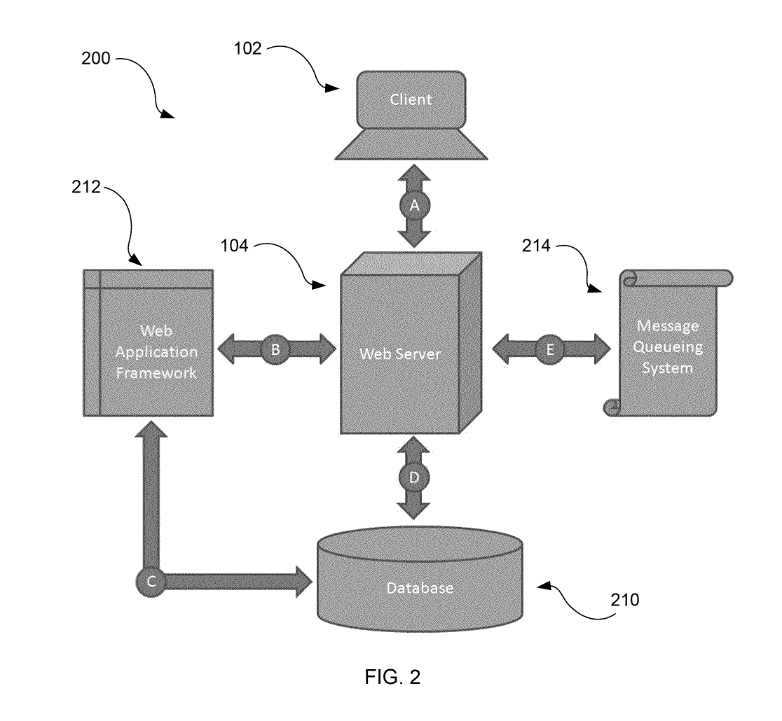

FIG. 2 is a schematic of an example of a system architecture 200 that enables the formation of groups for collaborating around common content over a network. For ease of viewing, only a single client device 102 is shown, though multiple client devices 102 can connect to the application server 104 simultaneously. Similarly, the application server 104 can correspond to a single server or multiple servers operating in conjunction with one another.

The system architecture 200 makes use of several interoperating components. For example, the system architecture 200 can include a database 210 (e.g., Cassandra (available from http://cassandra.apache.org), Hadoop (available from http://hadoop.apache.org), MongoDB® (available from 10gen, Inc.) or MySQL™ (available from http://www.mysql.com)) to handle data management, including user accounts, group state and statistics, lead history, among other data. The application server 104 can include any applicable web server such as, for example, Apache™ (available from http://httpd.apache.org), Node.js (available from http://nodejs.org/), Twisted (available from http://twistedmatrix.com), MongreL2™ (available from http://mongrel2.org), that supports a web application framework 212 (e.g., Django® (available from Django Software Foundation) or Node.js™ (available from http://nodejs.org/)). The web application framework 212 provides services such as, for example, authentication, dynamic webpage generation, and an interface front end to the database 210. Django® is a powerful Web Application Framework, providing support for numerous backend databases, powerful authentication, dynamic webpage generation, and URL-address parsing. As Django is written in Python, a powerful scripting language, it is well suited for parsing and manipulating various forms of text-based data, such as HTML, XML and human-readable data, like chat messages.

The database 210 can be stored as part of the application server 104 or can be a part of a stand-alone database server communicatively coupled to the application server 104. Examples of database management system for controlling, maintaining and using the database 210 include MongoDB® and Cassandra. MongoDB® is a scalable, high-performance, open-source NoSQL database management system that provides powerful replication and high availability, allowing horizontal scaling without compromising functionality. In addition, NoSQL database management systems are suitable for databases requiring many writes and sequential reads. This is in contrast to relational databases, such as MySQL, which are good for relational queries, but perform poorly for frequent writes and sequential reads, especially for massive quantities of data. Such a database management system provides many features well-suited to enabling collaboration groups, including rich, document-based queries, flexible aggregation and data processing, and the ability to store files of any size without complicating the stack. Perferably, the database 210 is configured to handle large amounts of data spread across many commodity servers, providing a highly available service with no single point of failure.

Messaging between group members can take place using real-time or non-real-time communication applications. For example, real-time aspects such as indicating user presence (e.g., informing whether a user or other group member is online, or in the group), text-based chat communication and leads can make use of a real-time, bidirectional, full-duplex communication channel, such as, for example, HTML 5 WebSockets (e.g., Pusher), Flash Sockets (e.g., Mongrel2™), or long-polling techniques (e.g., COMET as used in Orbited (available from http://labs.gameclosure.com/orbited2/) and a customized message queuing system 214 (e.g., ZeroMQ™ (available from iMatix Corporation), Pusher (available from http://pusher.com/) or RabbitMQ™ (available from VMWare®)). The customized message queuing system 214 allows hypertext transfer protocol (HTTP)-based connections to achieve real-time requirements without putting too much strain on the underlying system 200, facilitating its scalability. Other technologies, such as extensible messaging and presence protocol (XMPP) or internet relay chat (IRC) protocol, also can be used for the real-time communication and message queuing system 214. Using full-duplex communication channels, such as HTML5 WebSockets (as provided, for example, by Pusher), Flash Sockets (as provided, for example, by Mongrel2™) or long-polling HTTP connections (as provided, for example, by Orbited) and a Message Queueing System (using, for example, ZeroMQ) to handle the real-time delivery of group messages has several advantages. First, they scale well and put less load on servers than other messaging techniques, such as IRC or XMPP. Second, they allow the system to run over HTTP connection, meaning they are less likely to be arbitrarily blocked by corporate firewalls like other Instant Messaging system. Although both the application framework 212 and message queuing system 214 are shown in FIG. 2 as separate components from the application server 104, both the framework 212 and the queuing system 214 can run as applications on the application server 104.

Using the system architecture 200 shown in FIG. 2, several operating scenarios will now be described.

Authentication

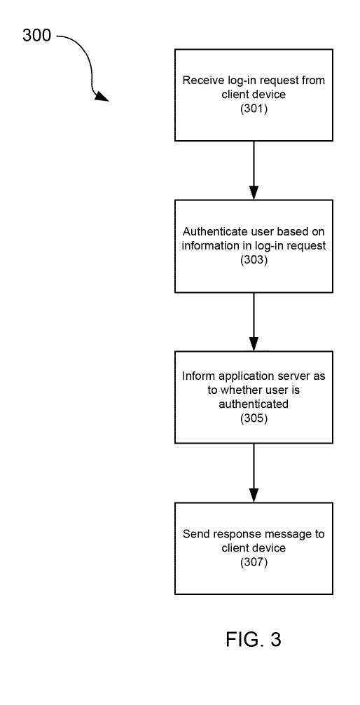

FIG. 3 is a process flow diagram that shows an example of an authentication procedure 300 using the system architecture 200. The authentication procedure 300 includes actions performed by the application server 104 as well as actions performed by applications operating on the server 104 such as the web application framework 212 and the message queuing system 214. Initially, the application server 104 receives (301) a login request from a client device 102 to access the collaboration groups. For example, a user operating a client device 102 may access a webpage hosted by the application server 104 and enter information, such as login and password, into the webpage. The login information is transmitted over a network to the server 104. Subsequent to receiving the user login and password information, the application server 104 transfers the login information to the web application framework 212 which authenticates (303) the user based on the information provided. Authentication of the user can include, for example, accessing the database 210 that contains user account information and binding the user's authentication state to a session. Binding the user's authentication state can include, for example, generating a cookie that is associated with the client device 102. Instead of requiring a username/password on later requests, the cookie can be used for subsequent requests for authentication from the client device 102.

The web application framework 212 then informs (305) the application server 104 as to whether the user is authenticated. In the event the user is authenticated, the application server 104 sends a response message (307) to the client device 102 operated by the user, in which the response message indicates whether the login was successful. As a result, the user is provided access and may join a collaboration group (based on a GroupID and a bootstrapping address, as described below). If the login attempt is unsuccessful, (e.g., due to an incorrect username/password combination), the response message may include a notice that the authentication credentials provided do not match the stored information, and the user operating the client device 102 can try again.

As explained above, once the client device 102 has successfully logged into the server 104, the session cookie associated with the client device 102 can be used for authentication on subsequent requests. This will be the case until at least one of the following actions occurs: the client device 102 logs out, the browser of the client device 102 is cleared, or the client device session expires (e.g., after some predetermined time-out period). Authentication with a session cookie occurs in the same manner as the login process described above; however, instead of authenticating with a username/password combination, the session cookie is used. Once logged into the system, each subsequent messages issued by the client device 102 to the server 104 are authenticated using the device's session cookie. The foregoing login/cookie authentication process typically occurs for every message sent from the client device 102 to the server 104.

Joining/Creating a Collaboration Group

Subsequent to authentication, the user may be able to join a pre-existing collaboration group or create a new collaboration group. For example, the application server 104 may post a new webpage to the browser of the client device 102, in which the new webpage includes a collection of groups from which the user can select. Alternatively, or in addition, the webpage can include one or more fields in which a user can enter a bootstrapping address (e.g., a URL) for a desired group.

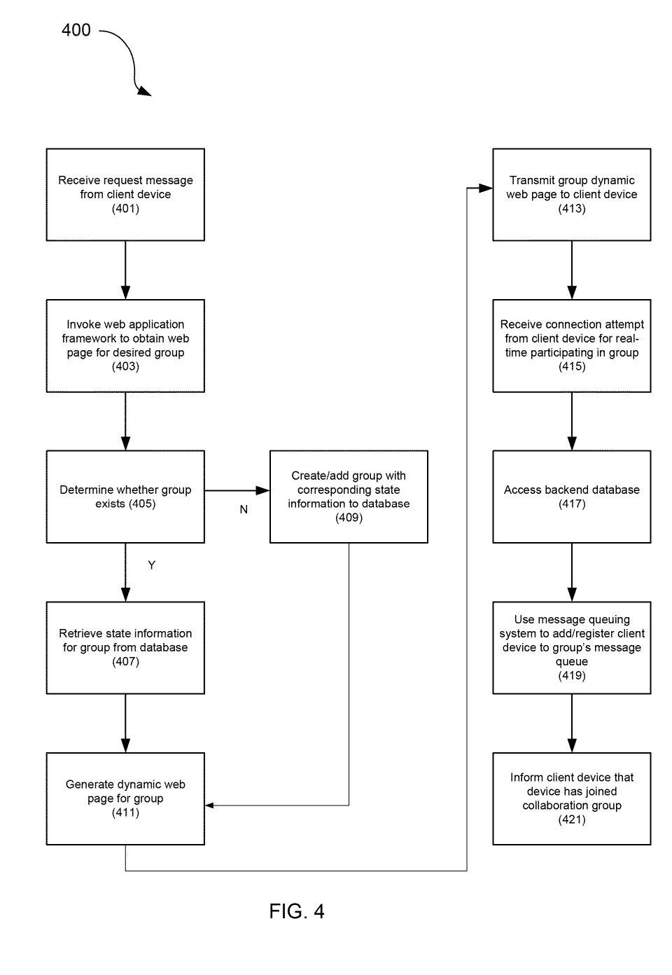

FIG. 4 is a process flow diagram that shows an example of a procedure 400 using the system architecture 200 that allows a user to join a pre-existing collaboration group or for creating a new collaboration group. The procedure 400 includes actions performed by the application server 104 as well as actions performed by applications operating on the server 104 such as the web application framework 212 and the message queuing system 214.

Initially, the application server 104 receives (401) a request message from the client device 102, in which the request message identifies a desired collaboration group using the group's bootstrapping address or in which the message indicates a request to create a new group. Upon receiving the message, the application server 104 invokes (403) the web application framework 212 to obtain a webpage for the desired group. The web application framework 212 consults the database 210 to determine (405) whether or not the group specified in the message exists. If the group exists, the web application framework 212 retrieves (407) the necessary state information for the requested group. If the requested group does not exist, the web application framework 212 creates and adds (409) a new group with corresponding state information to the database 210. Using the retrieved group's state information (whether from a pre-existing group or a newly created group), the web application framework 212 generates (411) a dynamic webpage for the group and returns it to the application server 104. The application server 104 then transmits (413) the group's dynamic webpage to the client device 102. The group's webpage and corresponding JavaScript (or other programming language), which reside locally in the web browser of the client device 102, connects (415) to the application server 104, attempting to setup the necessary connections for real-time participation in the group. The application server 104 accesses (417) the backend database 210 to extract and store any necessary state information concerning the group. The application server 104 then uses the Message Queueing System (419) to add/register the client device 102 to the group's message queue. If the group is newly created, a message queue is created for the group, before adding the client device 102 to the queue. Future group messages (e.g., chat messages, presence information (indication as to whether other users or group members are online or in a group), leads, seeks, etc.) destined for this particular group will be sent to the appropriate client devices associated with the group. The application server 104 then informs (421) the client device 102 that the device 102 has joined the selected or newly created collaboration group. This can include, for example, informing the client device 102 that a persistent, real-time connection is created between the client device 102 and the application server 104 to transmit group messages.

Group Collaboration Accounts

Each user of the collaboration group system is represented by a unique user ID. This user ID can be provided in various ways. For example, in some implementations, a user can simply create a unique user ID, much like creating a new ID for most systems on the web. The user enters a desired username and password and, if the username is not already in use, then it is bound to their newly created account. If the username is already in use, the user must choose another username unique to the system.

In some implementations, the user can use an existing online account to access the collaboration group system. For example, a user wishing to use collaboration group system without creating a new account may use an existing online identity, such as a Facebook, Twitter, or GMail account. Upon logging into collaboration group system with the existing online identity, a new account can be automatically created for the user. The user ID can be associated with the other online account's identity. For example, a user, John Smith, using his GMail identity, “john_smith@gmail.com”, would have a collaboration group account automatically created and assigned the username: “john_smith@gmail.com”. Because “john_smith@gmail.com” is necessarily unique to the GMail system, it will be unique to the collaboration group system as well. In some implementations, additional checks can be performed to confirm uniqueness of the ID. For example a check of the system's database can be performed to ensure that the user name is unique.

Furthermore, because his collaboration group account is bound to his GMail account, John Smith can easily post collaboration group GroupIDs (and/or their full bootstrap address), to his GMail services (e.g., GoogleTalk, Buzz, etc) without an additional login—by simply clicking a post button. For example, the collaboration group system can authenticate the user with the Gmail account using, for example, a session cookie, such that the authentication process with Gmail appears seamless to the user. Furthermore, users can add additional online accounts to their corresponding group collaboration account, making posting to these accounts even easier. For example, a user (e.g., John Smith) could add his Twitter, Facebook, AIM and other accounts to the group collaboration account, making it a single-click operation to advertise his collaboration group to these social networks. Should John want to change his user ID to something simpler than his GMail identity, he can do so, so long as his new ID is also unique to the group collaboration system. Thus, it's possible for John Smith, after having added his other social networking accounts to his group collaboration account, to change his username from “john_smith@gmail.com” to the more succinct “john_smith”—assuming “john_smith” is not already in use within the group collaboration system.

Sending and Receiving Group Messages

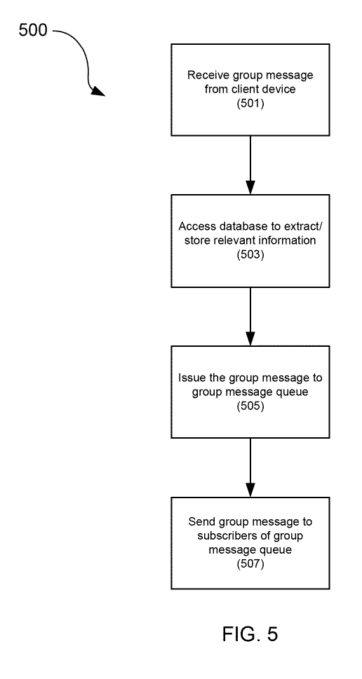

Once a user's client device is connected to a group, the user can send messages that are restricted to other members of the group. These messages can include, for example, chat messages, user presence information (e.g., whether another user or group member is available online or in the group, offline, away, or busy), leads, or seeks, among other types of messages. FIG. 5 is a process flow diagram that shows an example of a procedure 500 using the system architecture 200 in which a user sends a message to other group members from the client device 102. In an example implementation, the website hosted by the application server 104 includes a data entry field for entering a message to be sent out to other group members. The user can enter text (e.g., a lead containing a HTTP link to content, or a friendly message asking how the group or other users are doing) in the data entry field and then instruct the client device 102 to send the message (e.g., selecting the “return” key on a keyboard or by clicking on a button displayed on the webpage). The client device 102 then sends the group message to the application server 104 over a real-time connection. The application server 104 receives (501) the message from the client device 102 and accesses (503) the database 210 to extract and/or store relevant information, depending on the nature of the group message. For example, if the client device 102 issued a lead message, the application server 104 would store the lead itself, information regarding the entity that issued the lead, and/or information regarding the time the lead was issued, among other things, to the database 210. The information stored in the database 210 then can be used for later reference, such as displaying the group's lead history.

The application server 104 issues (505) the group message to the group's message queue in the message queuing system 214, ensuring the message will be sent out to all currently connected members of the group.

When a new group message is added to the group's message queue, the message queuing system 214 sends (507) the message to the subscribers of that group's message queue (e.g., the active client devices that are currently members of the group and that have been authenticated with the application server 104). These messages are sent to the application server 104 to be relayed to the client devices over their corresponding real-time connections. One copy of the message is sent out to each client device (not shown) currently subscribed to the group. Thus, each client device that has been authenticated by the server 104 and which is a part of the selected group receives the group message. In some implementations, this can even include the client device that originally issued the group message, such that receiving the group message acts as a confirmation that the message was successfully transmitted to the group. In some implementations, the client device 102 that issued the group message does not receive a copy of the original message. In the case of lead or seek messages that reference content, the client devices, upon receiving the lead message or seek message, then access and load the content specified by the lead message or load the content at a particular portion specified by the seek message, whether through the group webpage, JavaScript (or other programming language), or a web extension.

Obtaining Group Information

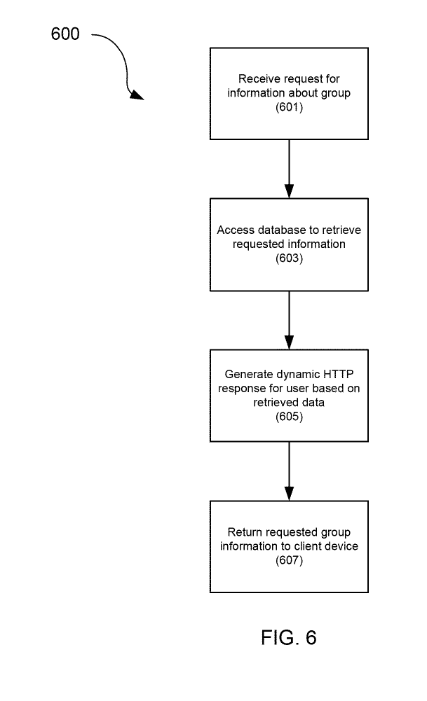

FIG. 6 is a process flow diagram that shows an example of a procedure 600 using the system architecture 200 in which a user obtains information about a selected group. Such information can include, for example, a lead history (e.g., the number of leads previously issued to the group over a specified period of time, the content of previous leads, or the issuers of previous leads), related groups (e.g., groups with which members of the present group may also be associated), among other information. Group information can be stored in the database 210. When a user wishes to obtain information about the group (such as its lead history, related groups, etc.), the user instructs the client device to issue a request for the desired group information. For example, in some implementations, the webpage hosted by the application server 104 can include interactive fields (e.g., buttons, pull-down menus, etc.) that allow a user to select one or more groups and request information about the selected group. Upon selecting a desired group, the client device 102 sends the request to the application server 104. The application server 104 receives the information request and forwards (601) the request to the web application framework 212. The web application framework 212 then accesses (603) the database 210 to retrieve the requested information about the group. The web application framework 212 then generates (605) a dynamic, HTTP response for the user based on the retrieved data and returns it to the application server 104. The web server then returns (607) the requested group information to the client device 102.

Other System Architecture Implementations

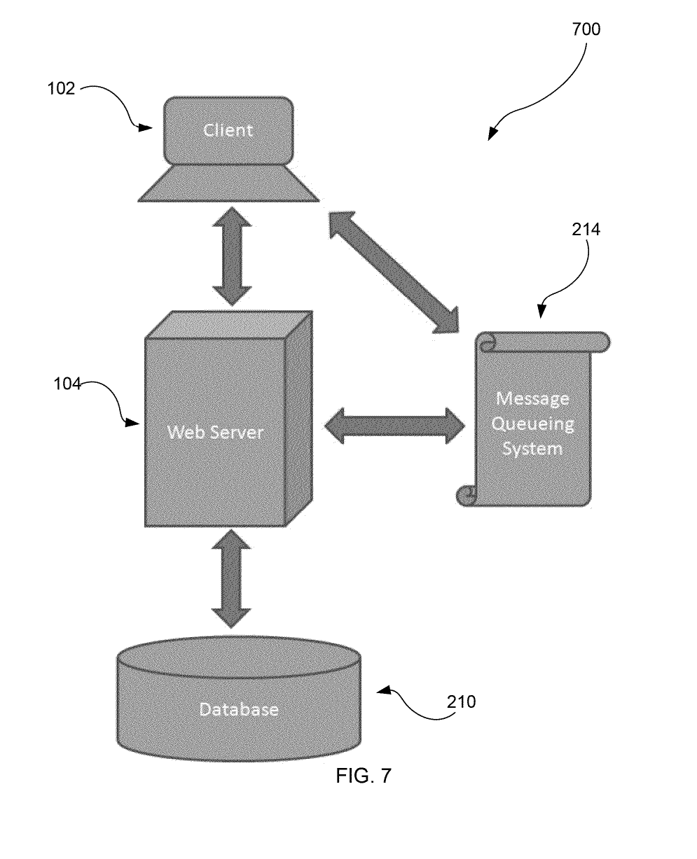

As explained above, the foregoing scenarios (e.g., authentication, sending/receiving group messages, obtaining group information) can be performed using the system architecture of FIG. 2. However, other system architectures also may be used to obtain the same results, while enabling users to independently and simultaneously access common content. For example, FIG. 7 is a schematic diagram of an example of an alternative system architecture 700. In the architecture 700 presented in FIG. 7, the web application framework has been removed, and the application server 104 (e.g., a web server) performs the tasks of the web application framework, such as authentication and dynamic webpage generation. “Node.js” is an example of an application server that performs both the server and application framework responsibilities.

In addition, the message queuing system 214 of architecture 700 can communicate directly with either the application server 104 or with the client device 102. An example of a message queuing system capable of directly communicating with a server and/or client device is Pusher™ (available from Pusher Ltd.). A message queuing system capable of directly communicating with a server and/or client can, in some implementations, invoke less strain on the application server 104 by bypassing the server 104 for real-time message delivery. During operation of the system architecture 700, the message queuing system 214 may communicate with some combination of the application server 104 and the client device 102, where the combination can be configured to best fit the performance and functional needs of the overall system.

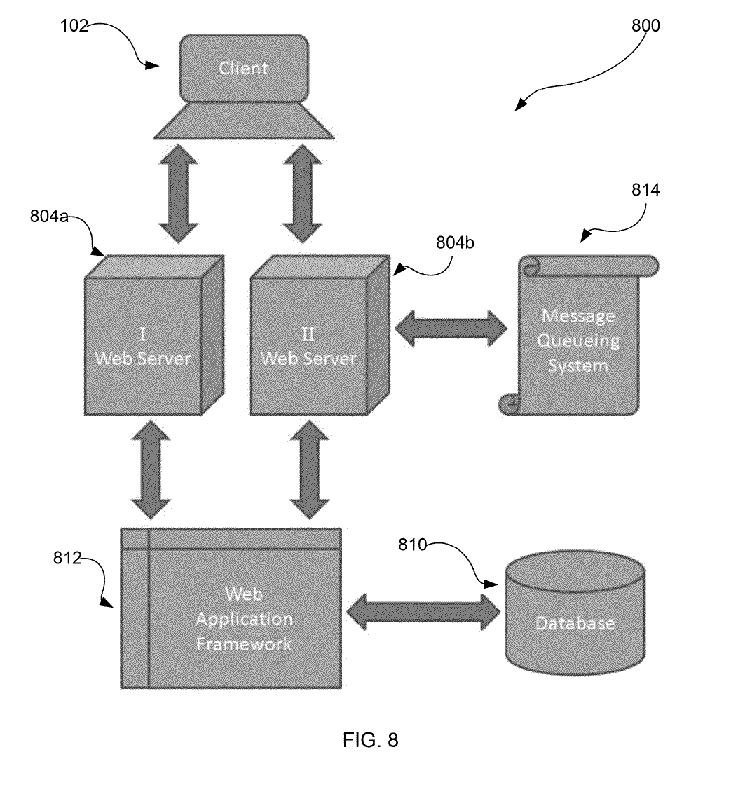

FIG. 8 is a schematic diagram of another example of a system architecture 800 that can be used to perform operations such as authentication, sending/receiving group messages, and obtaining group information, while enabling users to independently and simultaneously access common content. In the architecture 800, there are two application servers (e.g., a first web server 804a such as Twisted (available from http://twistedmatrix.com) and a second web server 804b such as Mongrel2™). The first web server 804a handles login, joining/creating groups, and obtaining group information. The second web server 804b handles sending and receiving real-time group messages and using the message queuing system 814. Both web servers make use of a web application framework 812 for authentication and accessing the backend database 810. By splitting the operations of a single web server across two different web servers, the individual load on a single server decreases, thus allowing both servers to be optimized for more specific, specialized tasks. Additionally, the real-time component (performed by web server 804b) can be scaled independently and more rapidly than the non-real-time component (performed by server 804a). Since there is generally more strain on the real-time server relative to the non-real-time server, there is a marked benefit to splitting the two functionalities of the system in this way. These components are highly scalable and work well with clustering.

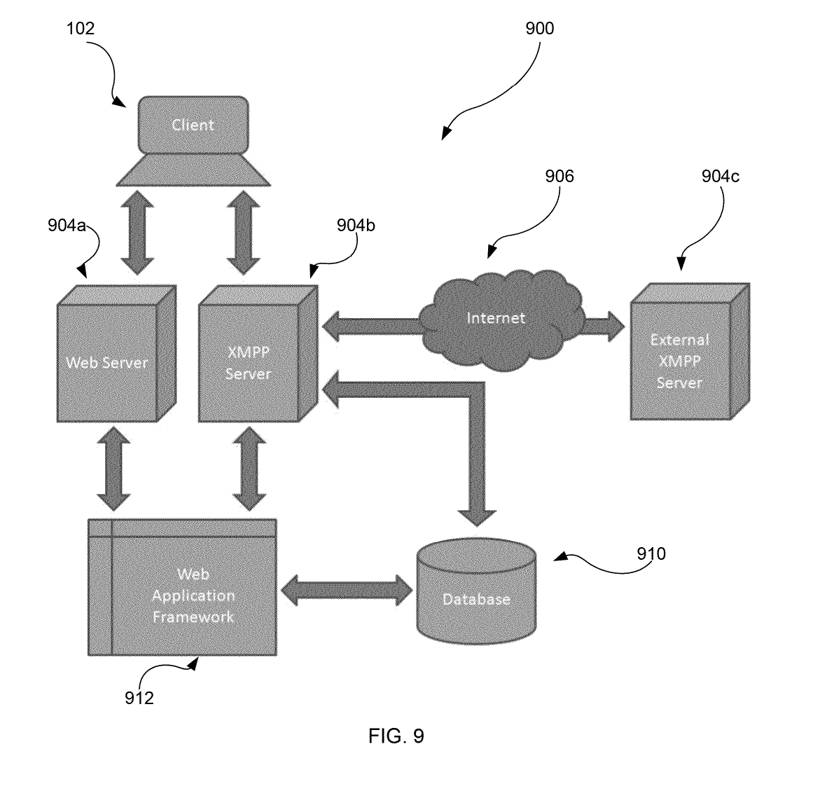

Other technologies, such as XMPP or IRC protocols, can be substituted for the real-time communication and message queuing system. Although the XMPP and IRC protocols may not scale as well or work as seamlessly behind firewalls as other real-time communication solutions (e.g., HTML5 WebSockets, long-polling, etc) and message queue systems, they can achieve similar results for group messages (e.g., chat, user presence information, leads, seeks, among others). FIG. 9 is a schematic diagram of an example of a system architecture 900 that makes use of XMPP to achieve group communication (replacing the message queuing system shown in the previous system architectures). The system architecture 900 includes a client device 102, a first application server 904a (e.g., Twisted web server), a second application server (e.g., XMPP server), a web application framework 912 (e.g., Django), a database 910 (employing, for example, Cassandra database management system), and a third application server 904c which can be communicatively coupled to the second application server 904b over a network 906.

In the architecture 900, the second application server 904b (e.g., an XMPP server) is used to handle group messages. The server 904b can communicate directly with the database 910 or indirectly through the web application framework 912. Also, the second application server 904b can authenticate locally, or can use an external XMPP server (e.g., third application server 904c) to authenticate. For example, server 904b can allow the user to make use of an existing Instant Message account, such as GoogleTalk, to join and participate in group communication, leads, etc. Other Instant Messaging services can be used to employ this aspect of the system, including proprietary systems, such as AIM® from AOL®.

II. Example Operations

An explanation of the system operation and account management will now be described using the system architecture 200 shown in FIG. 2. Other system architectures also may be used to perform the following operations.

Automatic and Manual Loading of Lead Content

Subsequent to joining a collaboration group, group members may receive messages from other members in the group, in which the messages correspond to a “lead.” As explained above, a lead is a message sent within a collaboration group that provides users within a group access or direction to particular content. A client device that receives a reference to content can load the content automatically (e.g., redirecting a web browser of the client device to an internet address where the content can be found). Alternatively, a user can cause the content to load manually upon receiving the lead. In some implementations, a user may be required to take some action (e.g., clicking a link contained within the lead) to cause the client device to load the content. The option of automatically or manually loading leads can be set on a group level, or set by individual users.

As an example, a user sends a lead to other members of a collaboration group, in which the lead references a webpage. For those group members operating under a default “automatic lead” mode, the members' web browser switch from the currentwebpage visible by each group member to the new webpage referenced by the lead. However, for those group members in the “manual lead” mode, the current webpage does not change upon receiving the lead. Rather, their current webpage remains visible in the browser, and the group members operating under the “manual lead” mode are alerted to the new lead (e.g., by a message queue of incoming “leads” displayed on the webpage as a list of leads). Only when the group member clicks to “follow” the lead (e.g., using an electronic mouse or other input device), does their current webpage change to that lead's content.

Queued vs. Live Leads

The collaboration group system gives users the ability to lead a group to new content. Leads can be live leads or queued leads. Live leads interrupt the current lead and load the new content immediately for the users within the group. Queued leads add the new lead to a lead queue where it becomes the active lead only after the leads that are ahead of it in the queue have been the active lead. Queued leads are implemented as the group's shared ‘Playlist’ in later examples; they allow for a more structured and orderly serving of shared content.

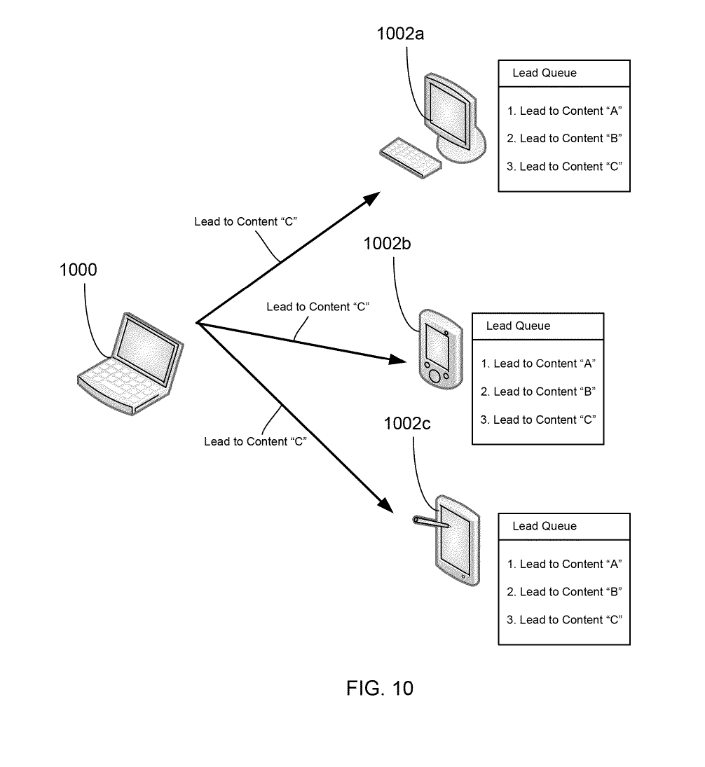

For example, FIG. 10 is a schematic diagram of multiple client devices that belong to a collaboration group. In an example procedure, a first client device 1000 in the group issues a lead to multiple other client devices (1002a, 1002b, 1002c) in the group. The lead contains a reference to content (e.g., content “C”). Upon receiving the lead from the first client device 1000, the lead is added to a lead queue that each client device in the group can display on the collaboration group webpage. Once the content from the prior leads (e.g., content “A” and content “B”) are accessed and loaded by the client devices associated with the group, the content from the most recent lead (lead to content “C”) then can be accessed and loaded.

Lead Feeds

Leads issued within a group are stored in a lead history in a database (e.g., database 210). The lead history includes group lead history and user lead history. User lead history is particular to each group member and includes references to the content to which the group member has led other users in the group. Group lead history includes references to the content to which all members of the group have been led. Much like a news feed, lead history can be viewed and subscribed to in a real-time feed format. The group lead history can be viewed by each group member or by members external to the group so long as the group is open to the public. User lead histories also can be viewed by users external to the group so long as the user makes his leads public. These feeds can power the leads of new and existing groups singularly or in combination. That is, by subscribing to some user or group lead history, it is possible to locate content to which one would desire to lead the members of his/her current group. In an example, if User A knows that User B performs good music leads, then user A can use User B's public lead history to music videos to lead user A's group of friends to similar content. Thus, User A is using User B's previously led content to ‘power’ or ‘drive’ the content conversation in User A's group. In another example, a collaboration group may subscribe to multiple lead history feeds from other collaboration groups and have those other feeds provide the next lead in the group itself. Lead history of a group or individual may also be advertised over existing social mediums, such as social network Twitter or Facebook status updates. For example, a lead history of User A can be instantly tweeted to User A's Twitter feed, or posted to User A's Facebook wall. When User A performs a lead, the lead would automatically show up as a tweet or Facebook post, thereby informing User A's Twitter followers or Facebook friends of what User A has led them to. Alternatively, User A could tweet or post a single link, which when clicked, would pull up User A's lead history (or subset of User A's lead history) for other users to view. The other user then can view that history, or subscribe to the history as a feed to view later.

Video Service

Once a group is created, it is considered “formed,” and can be advertised to other users interested in joining the group. Users that have joined a group are “group members” and can view other group member's online presence (e.g., whether the group member is logged in to the collaboration group system or available online) in that group. Group members can interact via text chat and by leading to content that they have searched for.

The group collaboration system offers group members the ability to view content, such as videos, at the same time, and in a synchronized manner. In an example, a group member chooses a video (e.g., a video accessible through a hyperlink, such as a video on YouTube) and sends a lead referencing the video to other members within the group. The client devices controlled by the other group members receive the lead and can automatically load the video. Several examples of using the group collaboration system to view videos will now be described.

For example, in the case of a YouTube video, the YouTube video can be loaded by the client device (e.g., both the client device that received a lead and the client device that sent the lead) in a JavaScript player and can be embedded in the collaboration group's webpage. On a mobile device, for example, the video can be embedded in a collaboration group mobile application, or it can be loaded by launching the mobile device's external YouTube video player, depending on the limitations of the mobile device. For example, the collaboration group mobile application can be a native application running on the mobile device. In some implementations, an embedded JavaScript player communicates with YouTube's API to load and play the streaming video. This embedded player technique also can be used for other streaming video content, depending on the content host's access policies.

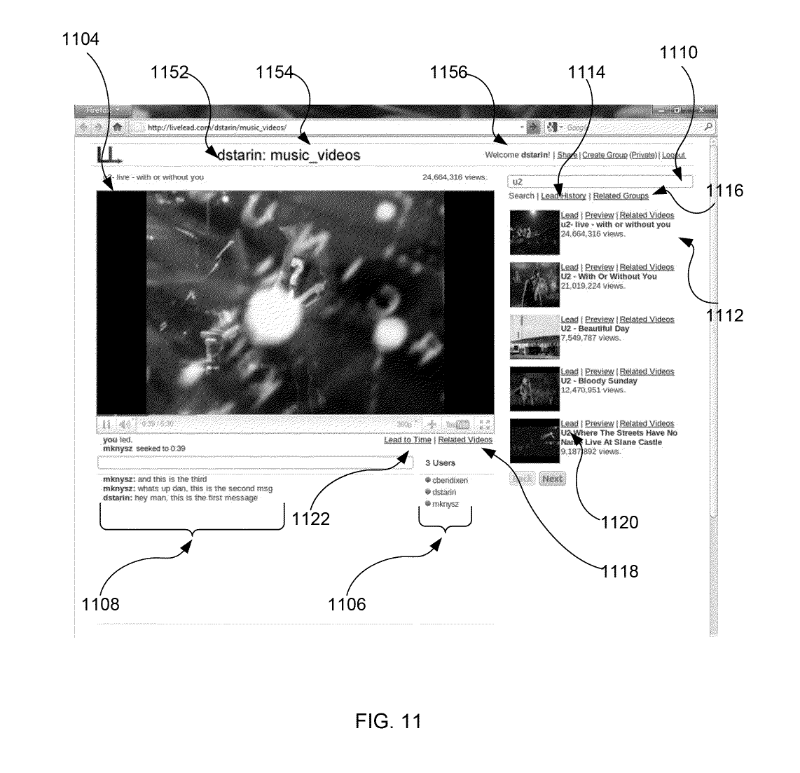

FIG. 11 is an example of a screenshot of a group webpage. In some implementations, group members can preview content in a small preview video pane. The larger video 1104 of “U2” is the video currently playing for each of the group members who are actively viewing the group webpage. The content 1104 also can be called the current lead. Unlike the lead video 1104, the preview pane in the implementation shown in FIG. 11 is not synchronized with the group. That is, each individual user can view content in the preview pane separately from other users in the group and cannot view what other group members are displaying in their respective preview panes. In this way, a user can peruse content without interrupting the group or fear of the content being inappropriate before leading to the content. A group member list 1106 lists users within the group that are currently present (i.e., the group members whose client devices are currently logged in and whose browsers are directed to the group webpage) by including a green dot next to their names. Text messages can be typed and received in an instant messaging field 1108 located in this example to the left of the group member list 1106. The group webpage can include a video search bar 1110. Search results 1112 can appear in the area below the search bar 1110. Group members may also select a lead history 1114. Upon selecting the lead history 1114 link, the group webpage will be refreshed to show the leads that have been issued in this particular group (similar to a browsing history in a web browser). Group members may also select a related groups link 1116. The related groups link 1116 shows the groups that were created off of the particular group with which the current group webpage is associated. Group members may also select a related videos link 1118. The related videos link 1118 can be associated with each video in the search results pane, lead history, or under the current lead video 1104, and when selected, returns search results related to the associated video. That is, the system can return a collection of video content that is based on a feature of the selected video, in which the feature includes, for example, a genre, type (e.g., whether the video is a musical, cartoon, television show, advertisement, movie, short film), length, artist, source (e.g., video producer or user that posted the video), among other characteristics. For group collaboration pages that allow users to view content other than video (e.g., document file, audio file, webpage, image file), a similar related content button also can be used, in which the system, in response to a user selecting the related content button, provides a collection of content related to the selected content. That is, the system can return a collection of content that is based on a feature of the selected content.

Group member can generate a lead by selecting the “lead” link 1120 next to the thumbnails for search results. Also, while not shown in the screen shot, a sub group could be led to a related group; this is different than leading to the Related Group's video, because the sub group members are led to the Related Group itself and will follow that Related Groups subsequent leads. Leading a sub group (described below) to a related group causes all the members of the sub group to leave the current group web page and go to the web page corresponding to the related group. In some implementations, the members of the group can be led to the sub group web page in a new browser tab, thus maintaining each member's presence in the original group. That is, the sub group members are directed to a different URL/URI (e.g., groupID) and can participate in an new group. While a lead to content changes the content within the group we page, a lead to a different group actually changes the group web page (or opens a new browser tab that loads the new group web page). In the case that the sub group members leave the current group web page, the sub group member names would be removed from the list of current users in that group. The sub group members then can join the other group web page, and the sub group member names can be displayed in a list of members of the new group. Alternatively, if the sub group members do not leave the current web page and instead load a new web page directed to the new group, the sub group members would remain in the previous group as well, such that the sub group members effectively participate in multiple groups.

A group member viewing the group webpage may also select a “Lead To Time” link 1122. The “Lead To Time” link 1122 causes the current lead video to seek to that time for everybody. For example, if the link 1122 is selected for the current lead video 1104, every group member that is present has their video seek to the appropriate time. That is, the lead to time link 1122 would cause group member's lead video to jump to the specified time (e.g., 1 minute and 23 seconds into the video), and they would all see that video run from the same time (i.e., 1 minute and 23 seconds) on their respective client devices. The lead to features can also be performed for the preview videos. The identity of the user who performs a lead and/or a seek can be displayed in text under the current lead video. In some implementations, a button (not shown) can be added to the webpage that allows a user to synchronize the video they are viewing with the rest of the group. This “sync” button can be useful if the group member's video is delayed, or if the group member's video goes out of sync (e.g., if the group member decides to view or seek other portions of the video and then wishes to return to the point the rest of the group is watching). In some implementations, the group webpage can include a link (not shown) that allows members to add content to a shared group playlist. In some implementations, the group webpage also can include a link to remove content from a shared playlist.

Save or bookmark your discovered videos/content to your “Favorites” (i.e., heart icon) to show to other friends at a later time.

Pull in online (and offline) friends to the collaboration group from other, existing social platforms and communication systems, including but not limited to Facebook, Google+, Google Talk, Twitter, AIM, SMS/MMS, Email, phone contacts, etc.

A detailed description of how the collaboration group system operates will now be described with reference to a series of screenshots. After logging into the system, a user's client device is directed to a landing webpage, such as a large “holding cell” group page, where the “holding cell” group page displays a Related Group family tree that the user can traverse to explore different collaboration groups that are available. Alternatively, the user can be sent to a start page that displays Related Groups that have spawned from the start page. Unlike the “holding cell” group, the start page does not allow chat, indication of user presence, leads, or group videos; instead, the start page shows only the Related Groups and allows the user to join and travel through them.

Both types of landing pages (the “holding cell” group and the start page) can display an option to create a new group (e.g., as a link on the landing page). The mechanism for creating a group is the same whether the user is in a group, at the start page, or at a “holding cell” group: new groups are created by clicking a link or button on the page. The newly formed groupID can be generated automatically (so long as it is unique to the system) or the user can be allowed to choose a unique name for the group.

Also, the landing page that appears after a user logs into the system need not be limited to a holding cell showing related groups. Users can also create a customized “home” group to which they are automatically directed after logging into the system. When at the custom “home” group, a user can immediately start inviting friends to discover and share content. Alternatively, or in addition, the landing page that appears after a user logs into the system can display popular or featured public groups that the user can join. In some implementations, the landing page can display groups that a user's friends, family, acquaintances, and/or contacts are currently members of In certain cases, these other members will have to modify their profile settings so that the groups of which they are a part are made visible to other users. In some implementations, users can adjust their profile settings to make visible the groups with which they belong or their presence in a collaboration group “visible” to all their friends, family, acquaintances, and/or contacts, on the collaboration group system and other social platforms. In some implementations, users can adjust their profile settings to limit the number of friends, family, acquaintances, and/or contacts, on the collaboration group system and other social platforms that can view the groups to which the user belongs. Alternatively, or in addition, the user could specify for which particular contacts (internal or external to the collaboration group system) the user does not wish the groups to be visible. In some cases, the user can adjust their profile settings to select which groups will or will not be visible to others within the group collaboration system or external to the group collaboration system.

The following description references starts at the point where the user is already a member of a collaboration group, having entered the group's bootstrap address (in this case, the URL: “http://livelead.com/dstarin/music_videos/”) into a web browser, or clicked on a corresponding hyperlink from the landing page, or any other applicable mechanism that would bring the user's web browser to the desired group webpage. By entering a bootstrap address, the user can bypass the collaboration group main landing page.

As shown in FIG. 11, the group's bootstrap address is displayed in the browser's address bar 1150 (e.g., “http://livelead.com/dstarin/music_videos/”). In the event a user enters the address in their web browser without already being logged into the group collaboration system, the user will be blocked from accessing the group webpage. The group webpage displays in the group member list 1106 other users that are currently present. As shown in the example screen shot, there are three users currently present (e.g., cbendixen, dstarin, and mknysz). FIG. 11 also shows that the users have started text chatting in the instant messaging field 1108. At the top of the group webpage, the group creator 1152 is identified as “dstarin” and the group name 1154 is identified as “music_videos.” The group creator and group name are also reflected in the group's bootstrap address, though this is not a requirement of the system. In the present example, the group creator (dstarin) is the same as the user for which the screen shot was generated.

As explained above, the group webpage also displays a large video 1104 (titled “u2-live—with or without you”). This is the lead video, and it is what everybody in the group is watching together, synchronized, in real time. Below the video 1104, the group webpage displays the user that led the collaboration group to the video being watched. In the present example, the user leading the group is indicated with the text “You led.” The group webpage also can include a greeting 1156 to the group member currently viewing the page. In the present example, FIG. 11 shows a greeting 1156 that recites “Welcome dstarin!” The group webpage also can display whether other group members “seeked” to a particular frame of the video currently being watched. In the present example, FIG. 11 shows that the group member “mknysz” seeked to the time 0 minutes and 39 seconds of the video. On the right of the screen shot, FIG. 11 shows that a search for “u2” has been performed in the search bar 1110 and that there are five resulting videos from the search in the search results 1112 section. Additional search results for the search term can be found by clicking the “next” button at the bottom of the five search results. The group can be led to a video in the search results by clicking the “Lead” link next to the search results thumbnail. A search for videos related to any of these search-result videos can be performed by clicking the “Related Videos” link next to the thumbnails. A search can be performed on the currently led video (the large video in the picture, above the chat), by clicking on the similarly named “Related Videos” link below the video—doing so would show the related videos where the search results are currently displayed.

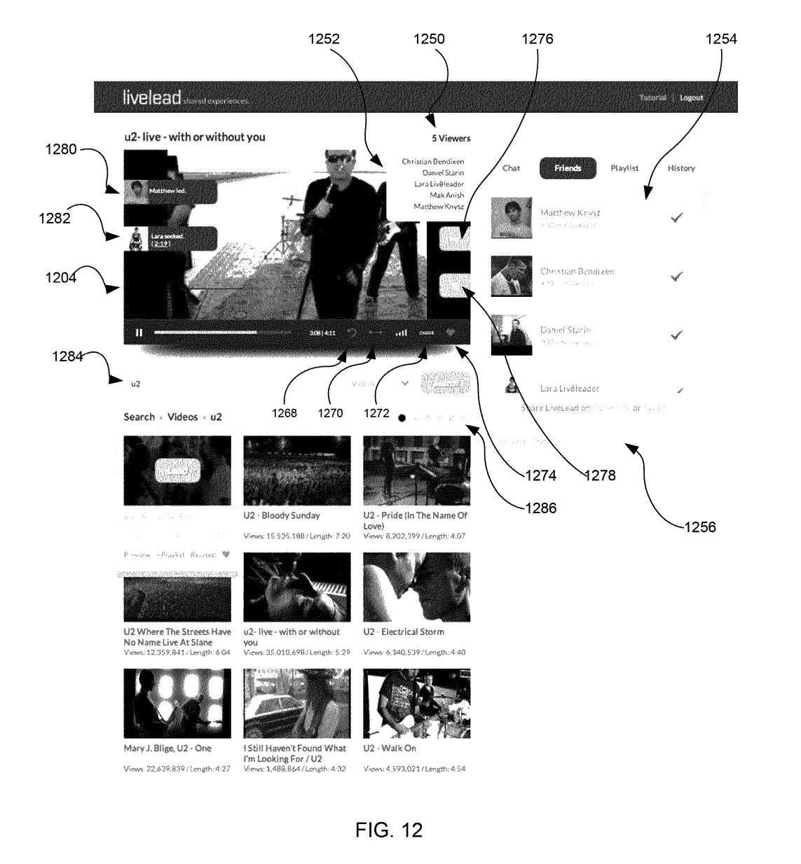

FIG. 12 is an example of a screen shot of an alternative design for a collaboration group webpage. Above the main lead video 1204 on the right, the group webpage displays the number 1250 of group members (“5 viewers”) that currently have the collaboration group webpage loaded on their web browser. When a user hovers their cursor (e.g., pointer icon) over the “5 viewers”, a text box 1252 is displayed that lists the group members that are participating in this collaborative group. The group webpage also can display these group members in a list 1254 adjacent to the lead video. The list 1254 in the present example is entitled “Friends”, and includes a picture of each user as well as a check mark, indicating that the user is in the group. The group webpage also can display a search box 1256 adjacent to the list 1254. The search box 1256 in the present example is a “search Friends” search box located beneath the list 1254 and allows users to perform a real-time search and filtering of contacts (e.g., family, friends and other connections) on the collaboration group system or other social networks, and messaging/email systems.

The lead video 1204 in the example shown in FIG. 12 includes several buttons and controls. In some implementations, the buttons and controls only become visible on the group webpage when a user directs their cursor over the video 1204 (e.g. hovers the cursor over the video). The controls can include, for example, volume control, play/pause control, video progress bar, video time indicator, sync button 1268, lead-to-time button 1270, share button 1272, favorite button 1274, next video button 1276, related video button 1278, among others.

The “sync” button 1268 can be used to synchronize the video being watched by the user to the same point in time in the video being watched by the other members of the group. The “lead-to-time” button 1270 can be used to lead the group to a specified point in time in the video. This can be used to seek everybody in the collaboration group to a time in the video currently being viewed by one of the users. Thus, for example, a group member could skip ahead in the lead video currently playing, and then seek everybody to the same point in time of the video to skip undesired or unnecessary content. Conversely, a group member could also skip backwards in the video to replay content and lead others in the group to that same prior point in time of the video. Thus, the synchronization feature enabled by the “sync” button 1268 affects only the content accessed by the user selecting the button 1268, whereas the “lead-to-time” button 1270 (and the seek feature) affects everyone that is currently online in the group. That is, upon selection of the “sync” button 1268, only the content accessed by the user that selected the button 1268 will be updated such that the portion of the content accessed by the user is the same portion accessed by other users within the group. Upon selection of the “lead-to-time” button 1270, however, it is the other users (i.e., those that have not selected the button 1270) whose content will be updated to provide access to the same portion that is currently being accessed by the user that selected the button 1270.

The “share” button 1272 can be used to share the currently watched video on one or more social networks. For example, the share button 1272 could allow a user to post a video discovered in the group to their Facebook wall. The “favorite” button 1274, which is shaped in the example screen shot like a heart, allows users to bookmark, or save, a discovered video to their personal collection, allowing them to lead other people to it at a later time. The lead video 1204 also includes a “next video” button 1276 (shaped as two right-pointing arrows in the example screen shot). The next video button 1276 allows a user to skip the remainder of the currently playing video and causes the next video in the playlist to begin playing. The lead video 1204 also can include a “related video” button 1278 which allows a user to bring up search results of videos related to the currently playing video. The lead video 1204 also can include an indicator 1280 that displays the user who led to the current video being displayed. In the present example of FIG. 12, the leading user is identified as “Matthew.” The lead video 1204 also can include an indicator 1282 that shows the user who seeked, or led-to-time, in the current video being displayed. In the present example of FIG. 12, the user who seeked is identified as Lara, where she “seeked” at 2 minutes and 19 seconds into the video. That is, Lara skipped ahead 2:19 into the main lead video. The seek performed by Lara has no effect on anyone else in the group, until she presses the ‘lead-to-time’ button 1270, at which point the lead content (the U2 video) playing on the other group members' client devices simultaneously jumps (skips) ahead to 2:19 in the video.

Clicking on the indicator of who seeked will cause the user to issue their own seek to that time, making it easy to replay a particular part of a video. In the present example, the indicator informs the other group members that Lara was responsible for that jump (or seek) whereas Matthew led to this video.

The group webpage also can include a second search box 1284 adjacent to the lead video 1204. In the second search box 1284, a user can search for other videos to display. The search results can be displayed adjacent to the lead video 1204 (e.g., beneath the lead video 1204 as shown in FIG. 12). In some implementations, the group webpage will display thumbnails of the videos produced in the search results. In some cases, a user interface will appear over the thumbnails (e.g., if a user causes their cursor to hover over a thumbnail). The user interface provides the user with the controls, such as a control to “Lead” to the thumbnail video, a control to preview the thumbnail video, a control to add the thumbnail video to the group's shared playlist, a control to search for and display videos related to the thumbnail video, and/or a control to select the thumbnail video as a favorite so that the thumbnail video is saved/bookmarked. As shown in the example of FIG. 12, nine thumbnails are displayed on the group webpage. However, greater or fewer numbers of thumbnails may also be displayed.

The group webpage also can include pagination buttons 1286. When a user selects a pagination button (located directly above the search results in the example of FIG. 12), the selection of thumbnails being displayed will change be updated to a new collection of thumbnails.

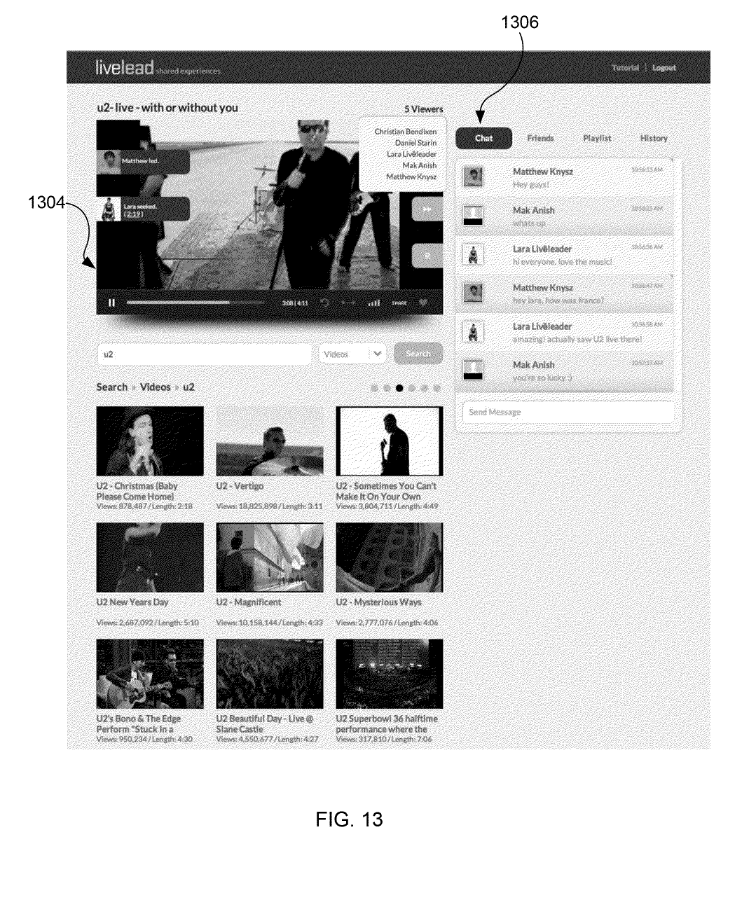

FIG. 13 is an example of a screen shot of an alternative version of the collaboration group webpage shown in FIG. 12. In the alternate configuration shown in FIG. 13, the “chat” area has been relocated from below the lead video 1304 to the right of the lead video 1304, accommodating the search results appearing under the video. A box 1306 can be used to indicate whether the user is currently viewing a chat, friends, playlist or history. For example, when a user switches from “chat” to “friends,” the box 1306 will move from the “chat” label and highlight the “friends” label instead. In the “chat” area, the group members can communicate with one another using, for example, instant messaging. The “chat” area can be configured to show a user's name, a thumbnail picture, and a time at which a message was sent.

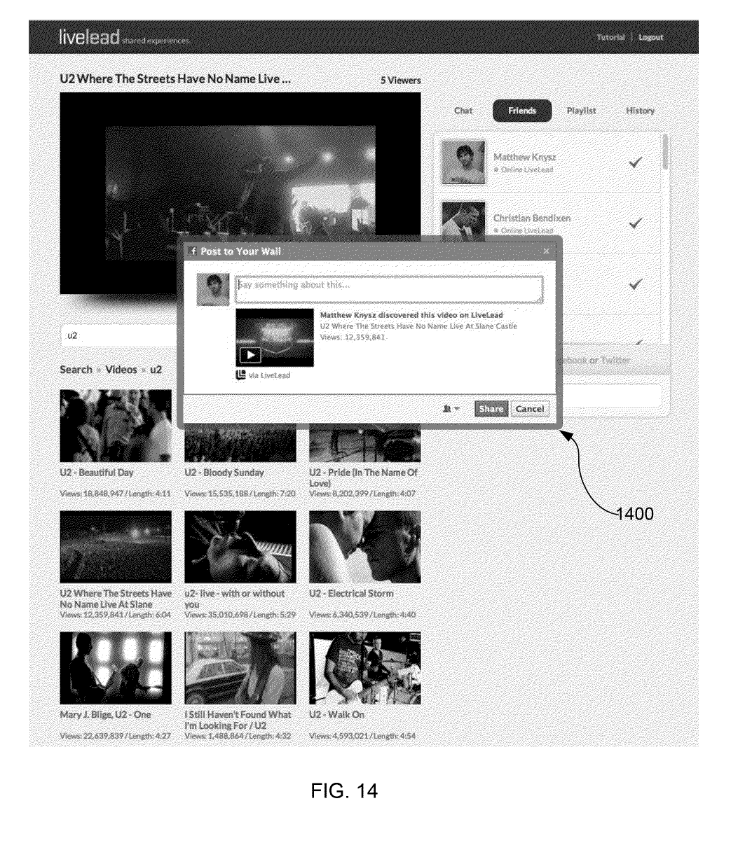

FIG. 14 is an example of a screen shot of the version of the collaboration group webpage shown in FIG. 13, in which a user has interacted with (e.g., clicked on) the share button on the main lead video's controls. The selection of the share button opens a dialogue box 1400 (e.g., a Facebook® dialogue) that allows the user to post the video to the user's social networking site (e.g., a Facebook® wall). The share functionality can be extended to other social networking applications, such as Twitter or Google+, as well as more traditional network communication applications, such as e-mail and instant messaging.

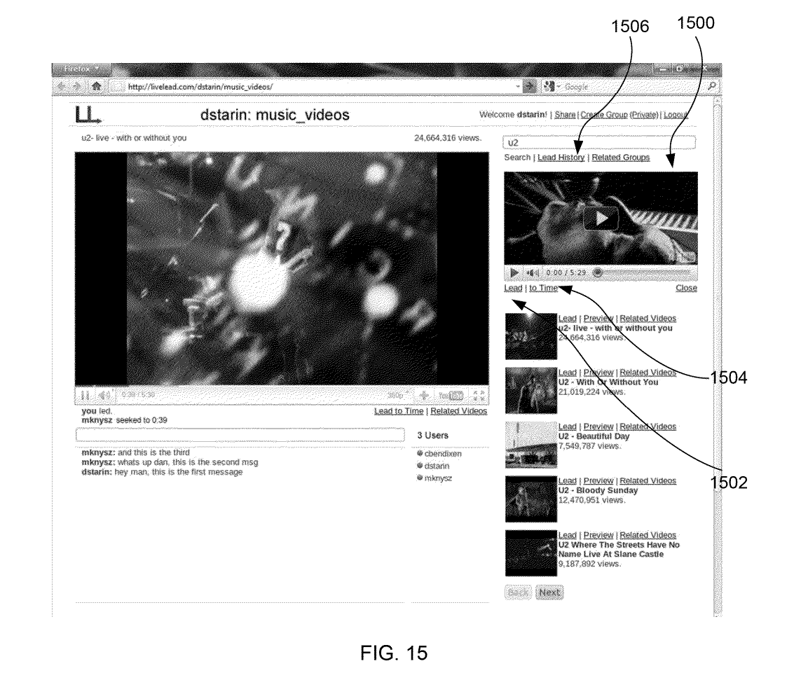

As explained above, the thumbnail videos may be previewed by selecting the preview link associated with the thumbnail. FIG. 15 is an example of a screen shot in which a user has selected a thumbnail to preview. As shown in FIG. 15, a preview window 1500 opens up in the group webpage, in which the preview window 1500 displays the selected video. The search results section, which displays the thumbnail videos, is moved down the page to make room for a smaller video preview of the selected video. In some implementations, the preview is viewable only by the group member who selected the video for previewing. The preview video can be closed at any time by clicking the “close” link under the smaller preview video. The preview video can also be associated with a “lead” link 1502 and a “to Time” link 1504. Selecting the “lead” link 1502 leads the entire group to the video currently being previewed, while selecting the “to Time” link 1504 leads the entire group to the currently previewed video and seeks everybody to the preview video's current time.

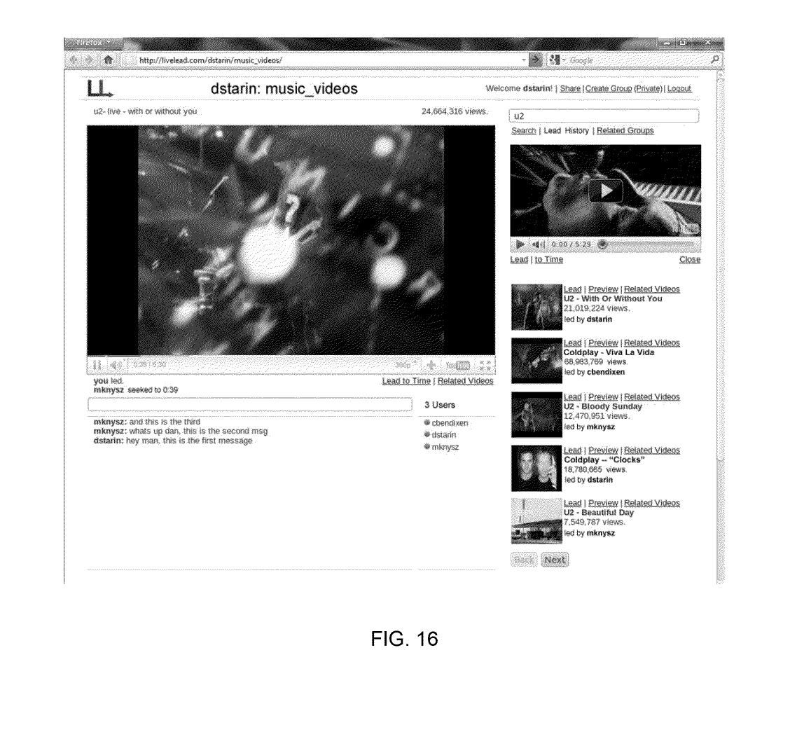

As explained above, a group member can also select the lead history link 1506, which would cause the webpage to display a list showing the collaboration group's overall lead history, as shown in FIG. 16. The “Lead History” and “search” links have changed appearances, indicating that the thumbnails below the preview video are now showing the lead history instead of search results. The lead history is similar to a web browsers history, only instead of showing the webpages that a group member has visited, the lead history shows the different videos the group has been led to, in what order the group has been led to the videos, and which group member performed the lead. The group's creator (or, in some implementations, a moderator of the group collaboration system) can clear the group's history, individually removing videos or clearing the entire history. The interface is identical to the search results, with the exception of indicating who led the group to this video (shown after the video's number of views next to the thumbnail). Similar to the thumbnails displayed under the search results, a group member can be led to, preview, or search for related videos of any of the thumbnails displayed in the lead history by selecting the corresponding links associated with each thumbnail. In some implementations, the preview video will not change when a user selects any of the search link, the lead history link or the related groups link, so that a currently displayed preview can continue to be viewed without interruption.

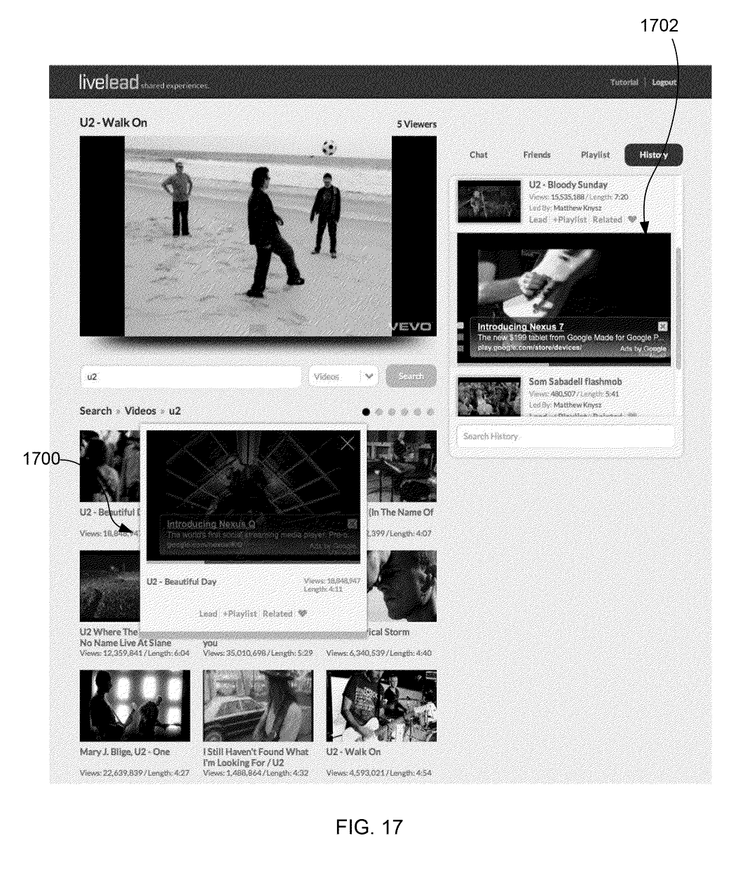

FIG. 17 is an example of a screen shot of a group webpage displaying an alternative configuration for previewing a video. As shown in FIG. 17, a video can be previewed in a floating preview box 1700 (e.g., the preview box overlays the group webpage as if the box were “floating” above the webpage). The floating preview box 1700 can include controls such as a control to lead to the thumbnail video, a control to add the thumbnail video to the group's shared playlist, a control to find videos related to the thumbnail video, and/or a control to add the thumbnail video as a favorite so the thumbnail video is saved/bookmarked. As in other implementations, the preview video can be restricted so that it is displayed only on the web browser of the group member that selected the thumbnail.

In the implementations shown in FIG. 17, previews of videos from both a lead history and from search results can be viewed, because the lead history and the search results sections are in separate, non-overlapping sections. For example, as shown in FIG. 17, a group member can simultaneously view a first preview in the preview box 1700 and a second preview in the preview box 1702. Similar to the “search Result” preview, the video being previewed in box 1702 can be restricted so that is displayed only on the web browser of the group member that selected the thumbnail. The preview box 1702 also can contain controls, such as lead, add to playlist, related videos, and favorite, as described above. In some implementations, either one or both of the preview box 1700 and box 1702 can be displayed as a floating preview box. Alternatively, either one or both the preview box 1700 and the preview box 1702 can be embedded within the group webpage.

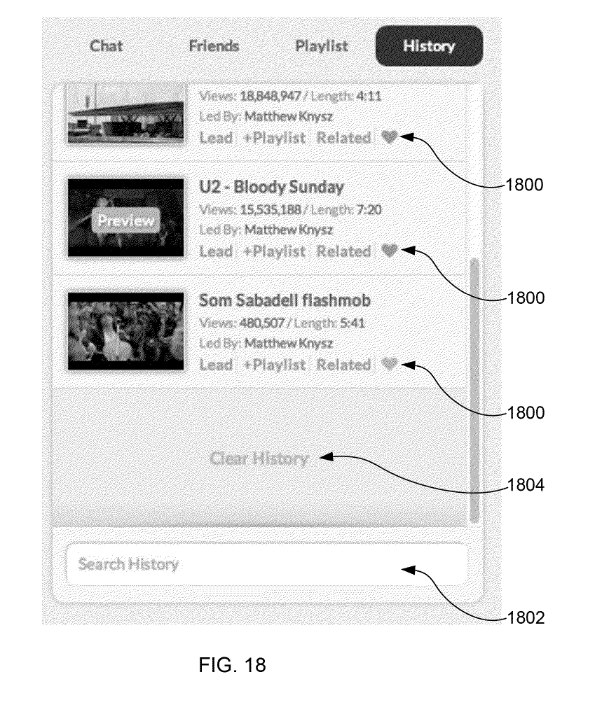

FIG. 18 is a screen shot that shows a portion of a group's webpage “History” when a video is not being previewed. In the implementation shown in FIG. 18, several thumbnail videos are displayed in which each thumbnail video is associated with information indicating, for example, which group member led to the video, how many views the video has received, and the length of the video. The thumbnail videos can be arranged in order (e.g., from top to bottom) based on how recent is the lead associated with the video. Each video can include controls, such as, for example, a preview control to preview that allows a user to preview the thumbnail, a lead control, an add-to-playlist control, a related videos control, and a favorite control, each of which functions as described above. In some implementations, the icon 1800 associated with the favorite control can be shaded a different color to indicate that the video has been added to the user's list of favorites. A group member can add or remove the video from the list of favorites by selecting the icon 1800. In some implementations, a search history text box 1802 also can be included under the history tab. By typing in the search history text box 1802, a group member can search and filter the group webpage “History” in real time. For example, when a user begins to type “bloody Sunday,” the number of videos listed in the “History” section of the group webpage would begin to decrease, until only those videos matching the entered search term were displayed. In some implementations, the group webpage also can include a link 1804 to clear the history section, such that the videos are removed from the system's memory. In some implementations, each thumbnail video in the history section can include a corresponding link that allows a user to remove the video from the history section.

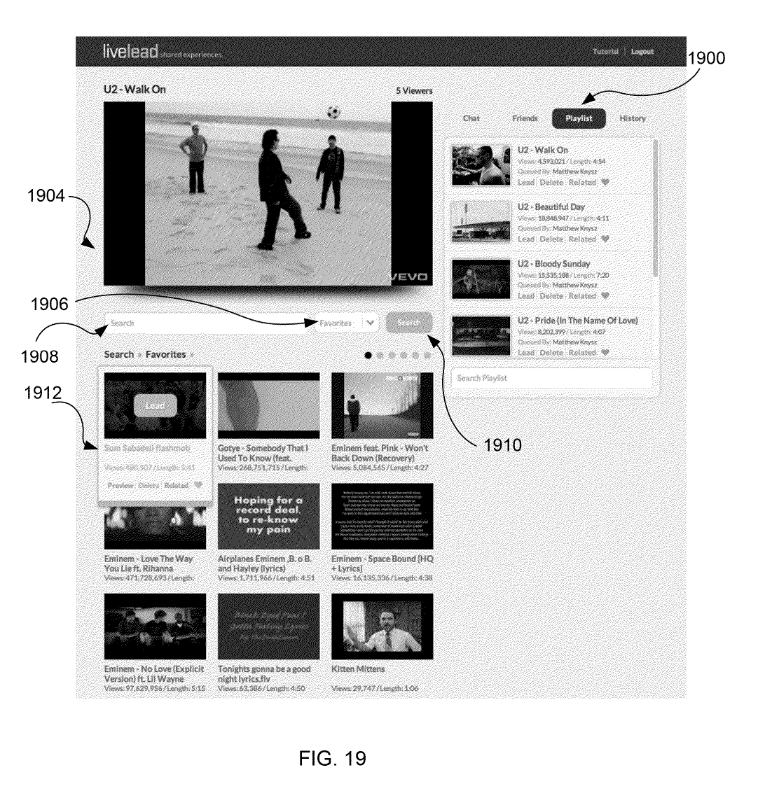

FIG. 19 is a screen shot of an example group webpage in which a user has selected the playlist link/button 1900. Upon selecting the playlist link 1900, the group webpage displays videos as thumbnails (e.g., from top to bottom), with a first item (e.g., the upper-most item) being the next video queued to play once the current lead video has completed. Items in the “Playlist” automatically play in order once the lead video has finished playing if no other leads have been issued. Items in the “Playlist” have most of the same functionality as items in the “History”, with the exception of the add-to-playlist button being replaced with a delete button, allowing users to remove an item from the “Playlist”. Items in the “Playlist” can be led, previewed, used to find related videos, and stored to the user's favorites. Additionally, they can be searched and filtered in real time by typing search terms into the box below the “Playlist” labeled “Search Playlist”.

FIG. 19 also shows a variation on how the user's “Favorites” can be displayed. Directly below the lead video 1904, where the user performs a video search, a drop-down menu 1906 is included and has the label “Favorites” and the user's “Favorites” are shown below the lead video in the same manner as search results. The thumbnails displayed as “Favorites” have the same familiar controls as search results, which are displayed, for example, when a user hovers the pointer icon over the thumbnail: lead, add-to-playlist, related and favorite (e.g., a hear icon). Each of the items in the user's “Favorites” will have the same colored heart icon, since these videos are already stored in the system database as the user's “Favorites”. Clicking the heart icon will remove the item from “Favorites” section, as it does elsewhere in the interface. Similar to the “History” and “Playlist” sections, the “Favorites” section can be searched and filtered in real time. As the user types the desired search term into the “search” box 1908 above the “Favorites” section (and below the main lead video), the group member's “Favorite” videos are automatically filtered and the most relevant results instantly shown, allowing users to rediscover their desired content. Like the search results, there are multiple pages of “Favorites”, which can be cycled through in the same manner, e.g., by clicking the grey dots below the “search” button 1910.

In some implementations, the “add-to-playlist” button will not appear with a thumbnail video. For example, in the thumbnail video 1912 the “add-to-playlist” button is replaced with a “Delete” button. Including the delete button instead of the add-to-playlist button indicates that the thumbnail video is already in the “Playlist”. Accordingly, by clicking the “Delete” button, a user can remove the video from the “Playlist”. This intelligent display of an “add-to-playlist” button versus a “delete” is present throughout the system anywhere that a video could be added to the “Playlist”, e.g., from search results, “History”, and/or “Favorites”. It would also be present in any other content display areas, such as, for example, displaying user recommended videos or lead histories from other groups.

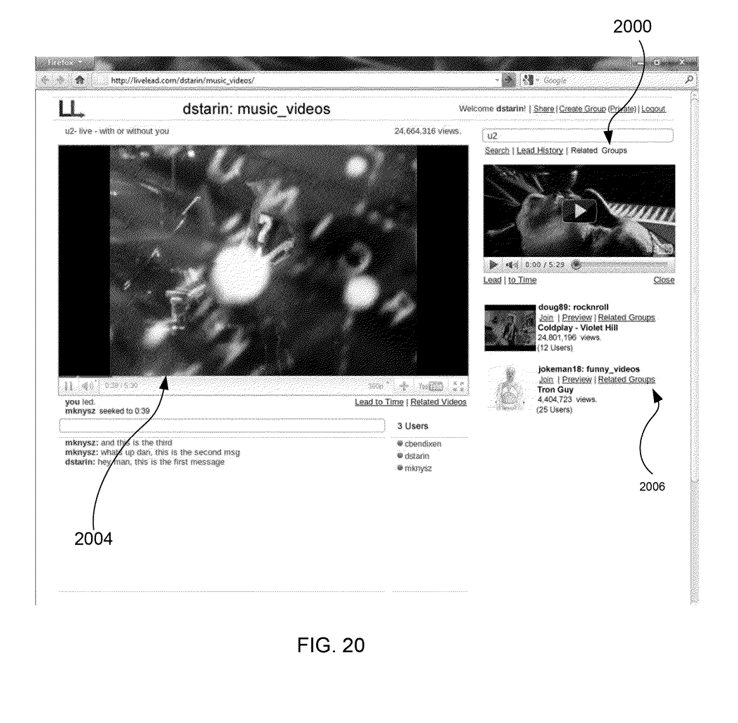

FIG. 20 is a screenshot of an example group webpage when a group member selects the “Related Groups” link 2000. Having clicked on the “Related Groups” link, the Lead History content is replaced with this group's “Related Groups,” i.e., groups that have been created from within the presently viewed group (i.e., dstarin: music_videos). In the example shown in FIG. 20, there are two related groups. The related groups are distinguished using their unique GroupID or some variation of the GroupID. In the present example, the GroupID is displayed as “username: groupname”. The thumbnail and title show the current video that one or more members of the related group are viewing. Additional information may also be displayed with the thumbnail such as, for example, the number of times the thumbnail video has been viewed as well as the number of users currently in the related group.

The thumbnail videos displayed under the related groups section also can include additional links. For example, the thumbnail videos can include a “Join” link, a “Preview” link, and a “Related Groups” link. Selecting “Join” will cause the user to leave the current group (e.g., “dstarin/music_video/”) and join the related group (e.g., “doug89/rocknroll/”). Selecting the “Preview” link will replace the preview video with that Related Group's currently playing video. Selecting the “Related Groups” link will replace the groups currently related to the lead video 2004 with groups related to the corresponding thumbnail video. Accordingly, a group member is allowed to traverse the related-groups family tree while remaining within the current group webpage (e.g., dstarin: music_videos).

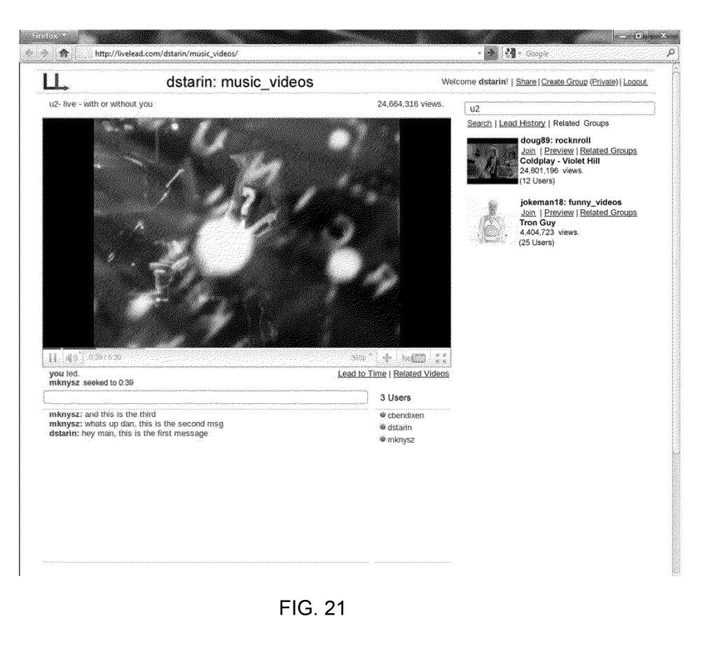

For example, clicking “Related Groups” link 2006 for the “jokeman18: funny_videos” group (associated with the “Tron Guy” thumbnail) will cause groups related to the “jokeman18/funny_videos” group (e.g., parent and child groups) to appear in the related groups section beneath the link 2000. The original preview video can still displayed, despite having moved into the “Related Groups” section. In some implementations, the preview window can be closed, as shown in FIG. 21. With the preview window closed, the Related Groups videos have moved up to reclaim the preview videos now vacant space. The preview video will remain closed until another “Preview” link is clicked, for example, next to another search result, lead history video, or related group video.

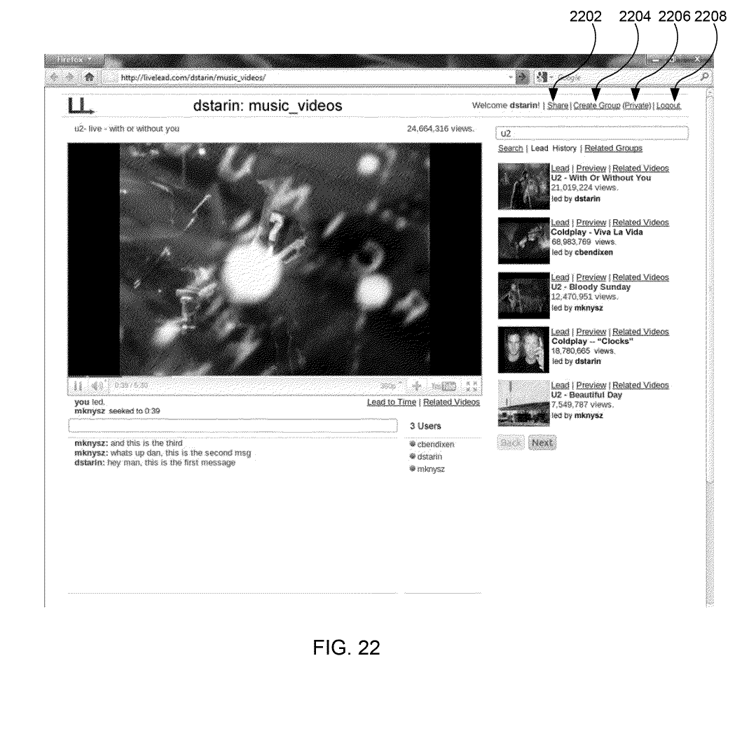

FIG. 22 is another screen shot of an example of a collaboration group webpage in which the preview window is closed. In this example, the group webpage also displays four additional links: a “Share” link 2202, a “Create Group” link 2204, a “(Private)” link 2206, and a “Logout” link 2208. As indicated by its name, the “Logout” link 2208 will log a group member out of the collaboration group system, causing the group member to leave the group, at which point the group member will be required to log back in before joining another group. The “Share” link 2202 allows a group member to share the presently viewed group with one or more contacts (e.g., friends, family members and other connections) through a variety of methods. The group can be shared at any time just by sharing or sending (e.g., by e-mail or by instant messaging) the URL (e.g., “http://livelead.com/dstarin/music_videos/”) to one's friends. However, the use of the “Share” link 2204 can make this process even more seamless. By selecting the “Share” link 2204, a group member can select another social network or communication mechanism to share the group's bootstrap address.

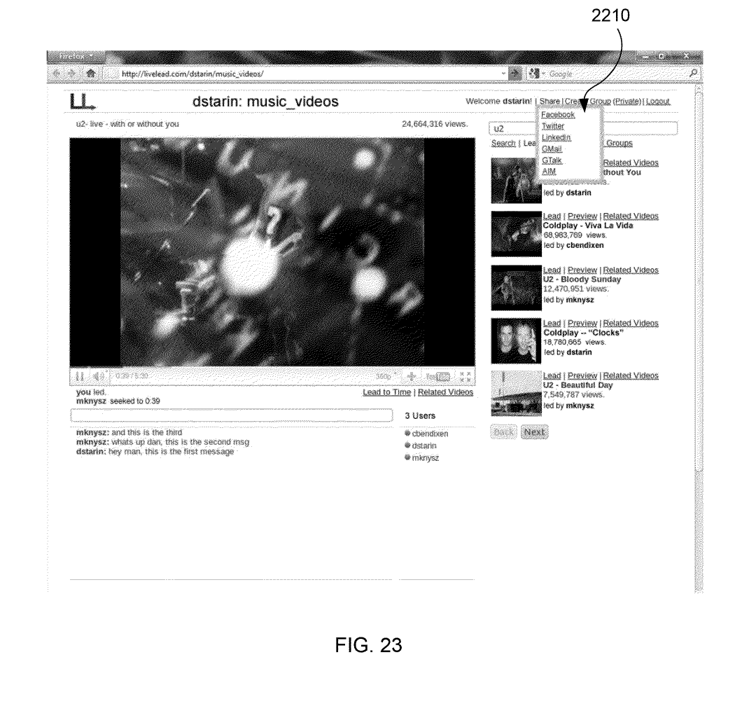

For example, clicking on the “Share” link can bring up a list 2210 of social networks and communication mediums in which the group's bootstrap address can be shared. FIG. 23 is a screen shot of an example group webpage after a user selects the share link. The social networks and communication mediums displayed after clicking the share link are examples and are not exhaustive of the different social networks and communication mediums that can be supported by the collaboration group system. When a group member selects one of the links in the list 2210, the group's bootstrap address will be posted via the communication medium selected. For example, by selecting “Twitter,” the group's bootstrap address would be posted to the group member's Twitter feed. If the group member is not logged into Twitter, the system will display a message asking the group member to login to Twitter to complete the post. Alternatively, if the group member has already bound their Twitter account to the group collaboration account, the bootstrap address will be posted without requiring the group member to login a second time.

In another example, when a group member selects a messaging application (e.g., “Gmail”) from the list 2210, the system will launch a new GMail message containing the group's bootstrap address. As before, the group member will be asked to login if they have not already done so. The group member will be queried as to which contact(s) the Gmail message should be sent. In another example, when a group member selects an instant message network (e.g., AIM or GTalk) from the list 2210, the group's bootstrap address will be posted to their status or in an instant message to one or more contacts that the group member specifies. Similarly, if a social network such as Facebook is selected from the list, the group's bootstrap address can be posted as a status update, as a private message to friends, or as a wall post, depending on the selection by the group member. Other social networks, messaging applications and communication media, such as, for example, Google+, Email, SMS/MMS messaging, and cell phones, can be used as well to share links.

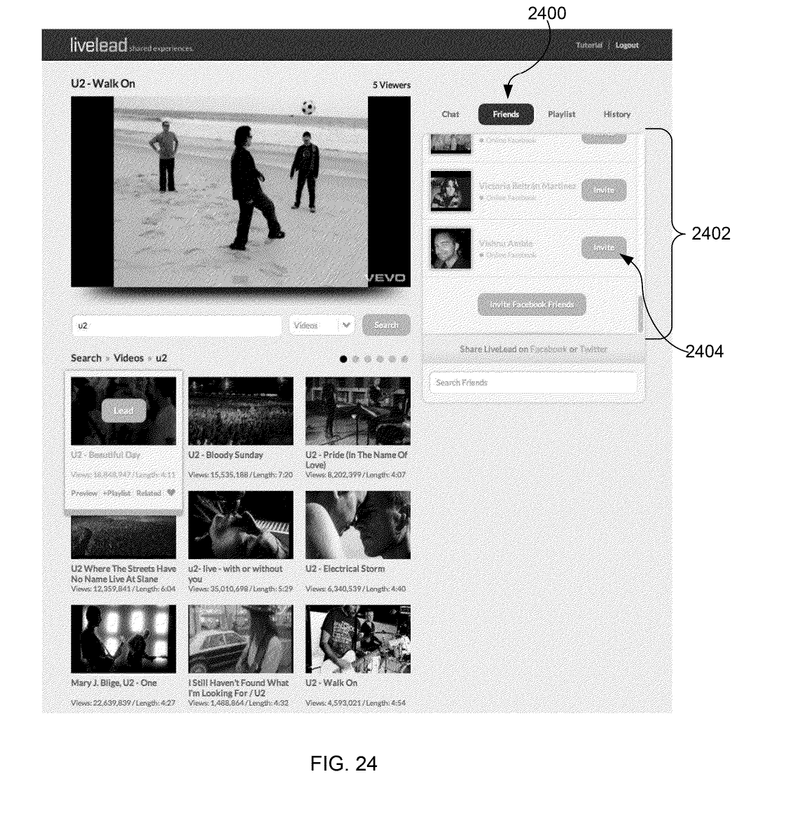

FIG. 24 is a screen shot of an example of a collaboration group webpage that utilizes two social networks: Facebook and Twitter. In the example shown in FIG. 24, the ‘Friends’ tab 2400 has been selected. In previous screen shots, the list of users displayed under the Friends tab 2400 included group members of the current collaboration group. In the present implementations, however, the list of users 2402 displayed beneath the Friends tab 2400 can include contacts and users from other social networks who are not members of the current group being displayed by the group collaboration system. As shown in the example of FIG. 24, the list 2402 includes a group member's Facebook friends. In some implementations, each user displayed in the list 2402 also can include a message indicator specifying that the user is currently online/available on their social network. For the contacts that are currently available, an ‘Invite’ button 2404 can be displayed adjacent to the user's name. If, however, a contact is offline, they may not be included in the list 2402. In some implementations, the offline users are included in the list 2402, but with a message indicator specifying that the user is currently unavailable.

In certain implementations, offline contacts can still be sent invites using the ‘Invite’ button 2404.

In some implementations, the group webpage also can include a search box 2406, in which a group member can perform real-time search and filtering of both their contacts who are members of the group collaboration system and their other contacts (e.g., contacts that are members of other social networking applications, e-mail contacts, phone contacts, etc.).

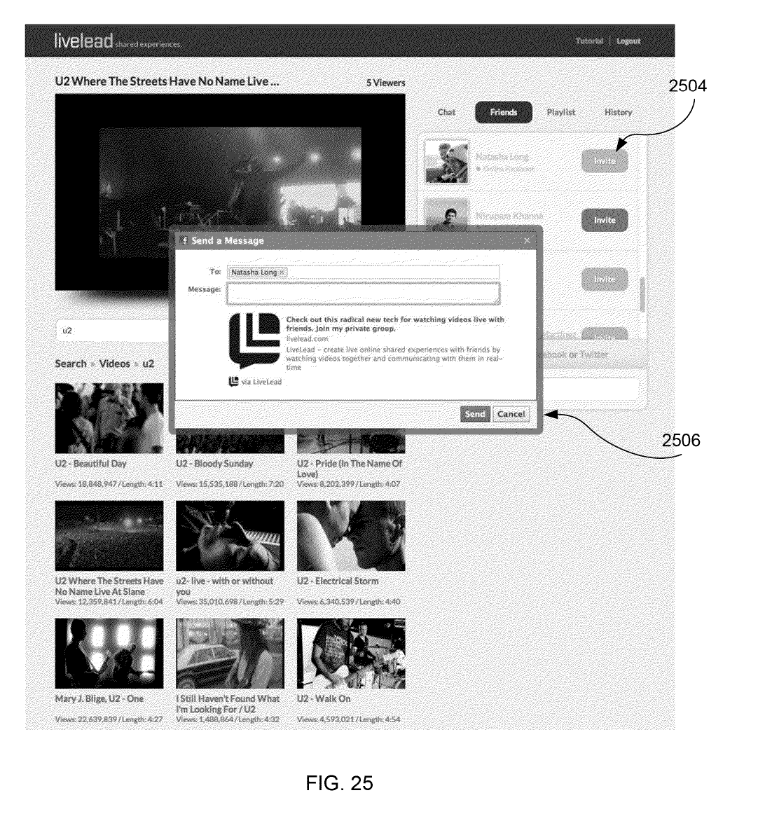

In some implementations, selecting the ‘Invite’ button will launch a dialogue box. For example, FIG. 25 is a screen shot of a collaboration group webpage in which a user has clicked on the invite button 2504 located next to the contact named “Natasha Long.” A dialogue box 2506 opens and automatically inserts the contact's name. The user can then type a personal message to the contact before sending an invitation to the contact, or just send the default invitation without modification. In some implementations, the user can also enter additional contacts (both online and offline) next to the selected contact and invite them all with a single message. In some implementations, the group webpage can include an invite button that is associated with a social network or other communication medium in general, and which is not specific to a particular contact. For example, the group webpage can display a button such as an “Invite Facebook Friends.” Upon selecting the “Invite Facebook Friends” button, a dialogue box would open, but without a preloaded name of a contact, such as Natasha's. Instead, the user would then have had to enter at least one Facebook friend to issue the invite.

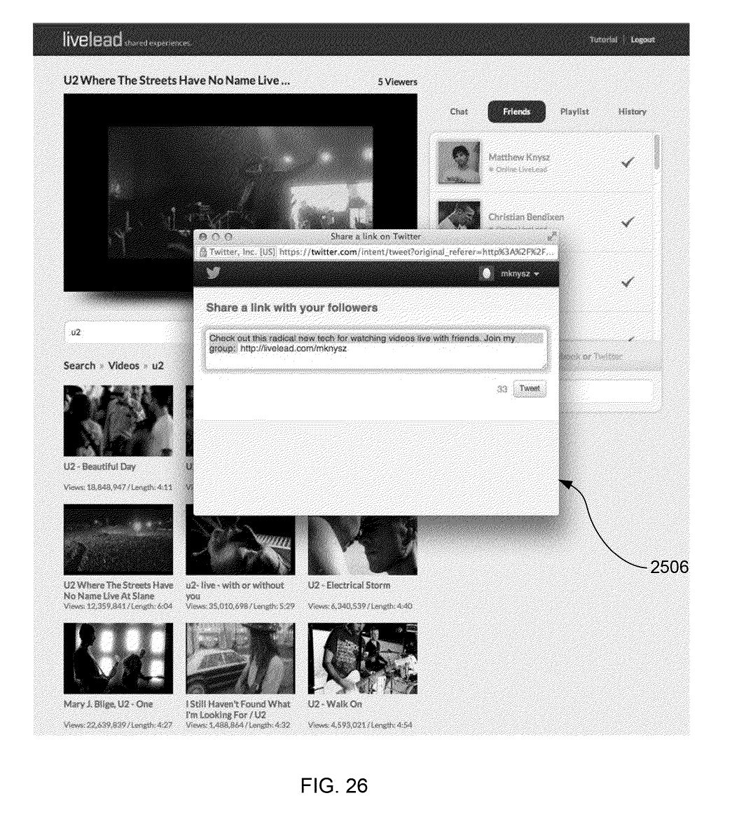

FIG. 26 is a screen shot of another example, in which a user elects to send an invite to a contact using Twitter. In this example of sending a Twitter invite, a Twitter dialogue box 2506 has been displayed with a preformatted ‘tweet’ advertising the collaboration bootstrap address. The user can modify this default message before clicking ‘Tweet’ to post to his/her Twitter feed.

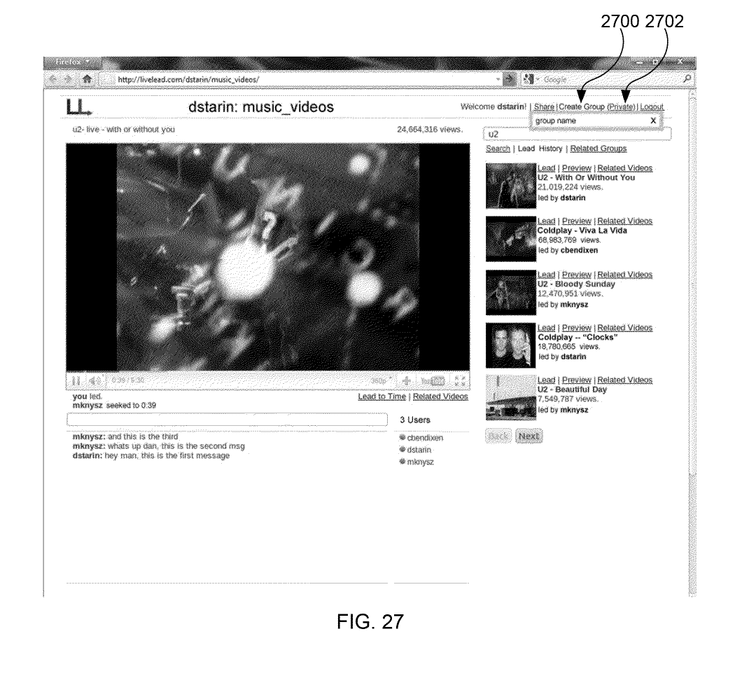

FIG. 27 is a screen shot depicting what occurs when a user selects the “Create Group” link 2700, creating a new group that is related to the current group. Clicking the “Create Group” link 2700 causes a text entry box to be displayed, in which a user can enter a name for the new group. The name can be used to form the GroupID. Alternatively, in some implementations, the system can generate automatically generate a unique GroupID). In the present example shown in FIG. 27, the GroupID is a concatenation of the user ID and the group name. Should a user enter a group name that has already been created under their user ID, the system can either respond with an error message or cause the user to join his/her already existing group, depending on the system set up. Once the name has been entered, the new group is created and is inserted as a child group to the current group's related-group family tree. The newly created group will now show up under the current group's “Related Groups” tab (e.g., as a child group). Conversely, if a user switches to the group webpage for the newly created group and reviews the “Related Groups” tab, the current group will appear as the newly created group's parent group.

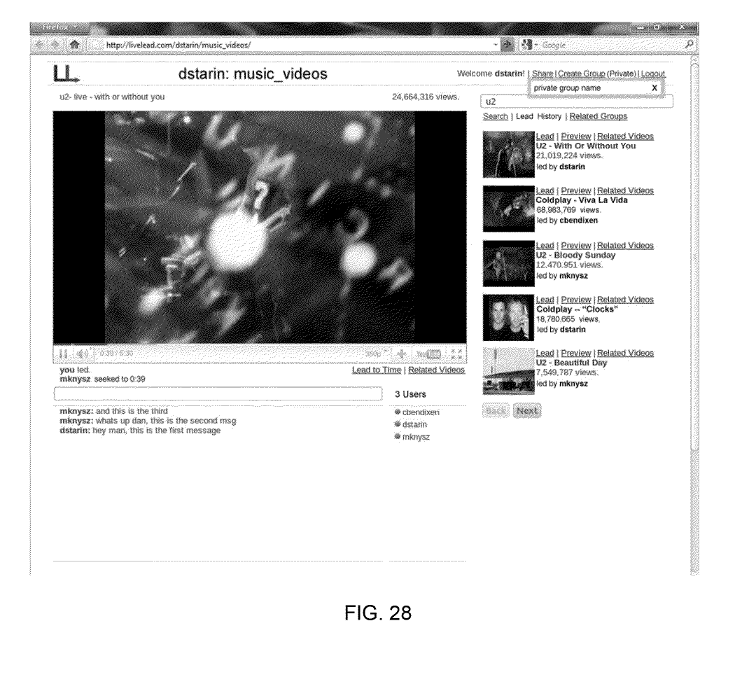

If the user wishes to create a new group and not have the newly created group appear in the related-group family tree, the user can do so by selecting the “Private” link 2702 (listed parenthetically after the “Create Group” link 2700 in FIG. 27). Selecting the “Private” link 2702 creates a new private group that is not connected to the currently viewed group through the related-group family tree. Thus, the new group cannot be joined by traversing the “Related Group” network, and must be found by explicitly using its group bootstrap address (or that of a child group of the newly created group). FIG. 28 is a screen shot that shows an example of group webpage when a user selects to create a private group.

Group Formation and Advertising

In the group collaboration system, a group is defined as a cohesive set of individuals interacting around similar content (e.g., the videos described in the previous section) and is identified by a unique GroupID. A group can be formed by users or automatically generated by the system. Groups contain certain state information, including the type(s) of interaction to take place in the group, the type(s) of content to be exchanged and the bootstrap address to join the group. All of this may occur with the click of a Create Group link on a website or the Create Group button on a tablet or mobile application. Once a member of a group, a user can be made aware of other members' presence in the group and can communicate with them using one or more communication mechanisms (e.g., text chat/instant messaging, VoIP, WebCam conferencing, e-mail, etc.). Furthermore, members of the group are affected by the Leads issued to that group, in which all members of the group can have access and experience the same content, whether the content is webpages, photos, or videos, among other things.

A collaboration group is advertised by sending or posting a message indicating the bootstrap address of the group. The bootstrapping address is a URI that contains the group's unique GroupID. The GroupID is a unique identifier for the group, distinguishing it from all other groups in the system. The GroupID can be anything, so long as it uniquely identifies the group within the system. For example, it could be a unique hash value, an integer, or some human readable string. In the examples described above where users could lead and sync to videos, the GroupIDs are constructed from the group creator's unique user ID and a group name, which is chosen by the group creator. For example, the user “sam1991” might create a group named “fun_videos”. In this case, the group's GroupID would be “sam1991/fun_videos”. This particular naming convention is not a requirement of the system, but simply serves as an example. So long as the GroupID is unique within the system, any value for GroupID could be used.

Once a group is created, the group can be advertised by its bootstrapping address, which may be posted offline or online and typically consists of a URI, either full or shortened in the case of a redirect service. Some examples of advertising mediums include email, chat, radio, TV, Twitter, Facebook, Bluetooth, WiFi, WiFi SSIDs, Infrared (IR), location-based check-ins (i.e., using GPS and synchronous events), Radio Frequency Identification (RFID), Quick Response codes (QR codes), SMS/MMS text messages, and the WWW. Extending the GroupID example in the previous paragraph, an example bootstrapping address for the group “sam1991/fun_videos” might be “http://livelead.com/sam1991/fun_videos”.

In an example, a TV news outlet may want to supplement its news broadcast with Video content accessible by PC, tablet or mobile device. During the TV broadcast, the news outlet advertises that users can follow video content at “uled.us/abc7” (a shortened URL). The URI then redirects to a collaboration group webpage at “livelead.com/abc/group7,” where videos can be pushed to users that have joined the collaboration group in sync with the broadcast. Similarly, a user could create a collaboration group and advertise a short or full URI to friends, for example, through a communication medium such as email, IM, Twitter, Facebook, among others.

A collaboration group may be a public group or a protected group. A public group is available to anyone who has seen an advertisement of the group. Protected groups are only available to a set of users, either by invitation, knowledge of a passcode, or membership in a particular collaboration group or set of groups supported by the system. Some ways to advertise the bootstrap URI (or short URI) include, but are note limited to, through email, chat, radio, TV, Twitter, Facebook, or other Social Networks, Bluetooth, WiFi, WiFi SSID, Portal, Distributed Links, SMS/MMS text messages, RFIDs, QR codes, IR, location-based check-ins, and P2P Bootstrap.

Methods of Group Interaction

A collaboration group can support one or more forms of interaction among members. The types of interaction can include, but are not limited to, instant messaging (i.e., group text chat), voice-over-Internet Protocol (VoIP) and WebCam conferencing, and Twitter. In some implementations, presence (i.e., information indicative of user availability in a group or online) is a feature of the group interaction regardless of the group interaction supported.

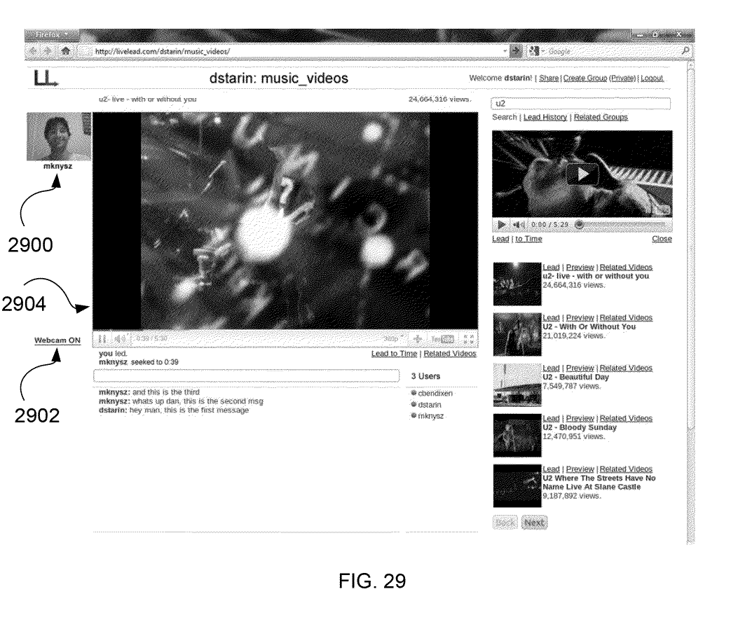

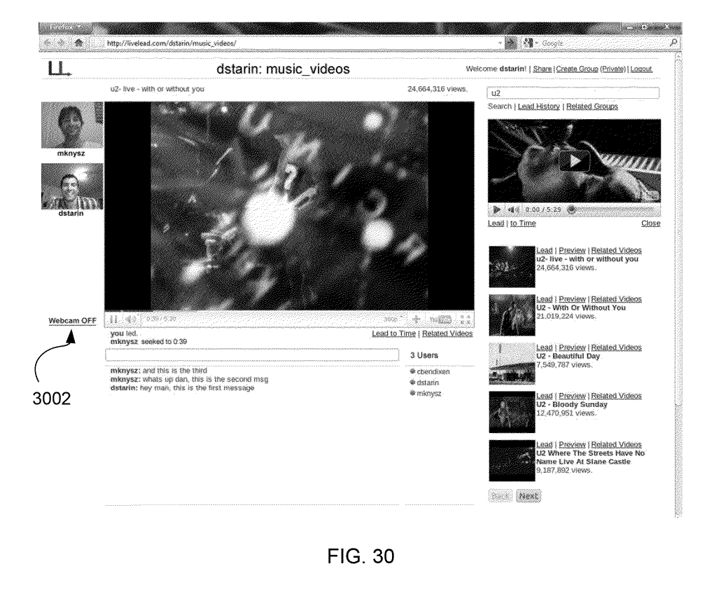

In some implementations, group interaction history can be stored and made available depending on the type of interaction and privacy settings. For text chat, it is useful to store some recent history so that new users have some context to interact when they join the group. FIG. 29 is a screen shot of an example of how WebCam conferencing could be added to video collaboration group webpage._As shown in FIG. 29, a webcam feed 2900 of the user “mknysz” is visible to the user “dstarin” to the left of the main lead video 2904. While there are a total of 3 users in this group (i.e., cbendixen, dstarin, and mknysz), only user “mknysz” is using his webcam. The screen shot above shows the group view from the standpoint of user “dstarin.” Since “dstarin” is not currently using his webcam, a link 2902 is available that gives the user “dstarin” the option to turn on his webcam. The link 2902 is labeled “Webcam ON.” Selecting the “Webcam ON” link 2902 will activate his webcam, as shown in the screen shot depicted in FIG. 30.

Having turned on the webcam, a webcam feed of the user “dstarin” has joined “mknysz” (e.g., in an area to the left of the main lead video 3004), and the other members of the group can now see and/or hear a webcam video of user “dstarin”. The “Webcam ON” link has been replaced with a “Webcam OFF” link 3002, as shown in FIG. 30, allowing “dstarin” to turn off his webcam and stop broadcasting to the group at any point.

Communication applications other than webcams also may be used such as text-based chat/instant messaging, which allows group members to type real-time messages to each other.

VoIP and WebCam conferencing allow the group members to communicate in a more natural and fluid way than typing. However, a user could also choose only to broadcast their image or voice independently. For example, if a user doesn't have a webcam, the user may select the VoIP aspect only. On the other hand, a user may broadcast only their image to the group, so that other group members can witness their reactions to leads, without broadcasting their voice; in this instance, the user would use a text-based chat mechanism to communicate. Additionally, the broadcast video/audio doesn't have to originate from a webcam or a microphone, but can be from a video/audio file. For example, in some implementations, a user could change a video/audio feed from a webcam/microphone to a video/audio file that is stored on the user's local computer or stored on a cloud service. Once the video is done playing, the user could substitute the stream with another video, or resume broadcasting from a webcam/microphone feed to the group.

For larger groups, it may be difficult to support large simultaneous video/audio streams. When groups contain hundreds to thousands of users, it might not always be possible to broadcast everybody's stream to everybody in the group. One solution is selective broadcast. Each user may only observe a specified number (X) of simultaneous streams. Which streams are viewed out of the potentially hundreds to thousands can be chosen in several ways. For example, users can selectively choose which people they would like to see streams from, with each user having a customized view of the users they are observing. In some implementations, the system can automatically choose which streams the user observes based on social connections or geographic locations. Alternatively, every user can observe the same X streams. In this instance, a queue system will be used. Users can grab one of the available X streams being broadcast to everybody in the group, in which case, one of the currently broadcasting users would stop broadcasting a camera feed (e.g., from a web camera) and be replaced by the new user, keeping the total number of simultaneous camera feeds constant. Different mechanisms for replacing current streams can be used, such as a first-in-last-out (FILO) queue. For example, if there are six webcam streams supported, and user seven grabs one of those six spots, the user who had held one of those spots the longest would be pushed out and replaced by the new user's stream. These selection mechanisms can be set by the Group Creator (or his/her chosen moderators) so that certain users' streams can't be pushed out (for example, the Group Creator's stream), allowing persistent broadcasters.

In some implementations, a communication application may not support all of the features of the collaboration group system. However, certain aspects may still be supported. For example, if a group creator (i.e., a user that created the group) modifies the settings of the group to support Twitter feeds, then users can subscribe to a certain Twitter feed or hash tag that corresponds to the particular group, thus allowing the users to use existing Twitter applications to continue to follow and participate in the text-based conversations and leads.

SubGroups

As explained above, a group can be understood as a cohesive set of client devices capable of interacting around similar content. In some implementations, the content can include other groups.

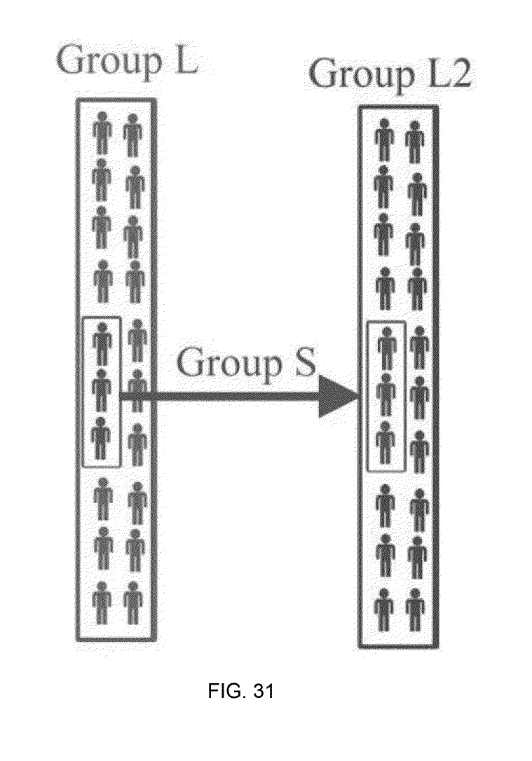

FIG. 31 is a schematic diagram depicting how content can include other groups. In the example shown in FIG. 31, there are two large collaboration groups supported by the system: Group L and Group L2, each of which includes multiple users. The system also supports a smaller group, Subgroup S, that includes three users. These three users have formed the Subgroup S, and have joined, as a cohesive social unit, the larger Group L. While joined with Group L, all members of Subgroup S can interact with the other members of Group L, including, for example, participating in leads or chats. However, as a smaller cohesive social unit, Subgroup S may also “lead” away from the larger Group L to another group, Group L2. In the same way a group member can lead to content, a user in Subgroup S can lead to other collaboration groups. This enables a group of friends to interact with one or more other groups of individuals, while still remaining tightly bound together as one social unit. For example, Subgroup S can communicate privately amongst themselves (without the larger group observing their conversation) or with the larger group L as a whole. In addition, Subgroup S can lead to content that is restricted to members of Subgroup S or also to members of the larger group L. Thus, members of a subgroup have the ability to communicate (e.g., through leads, chats, videos, etc.) among themselves outside of the larger group's channel. In the example of FIG. 31, members of Subgroup S can chat among themselves while still in Group L, without the other members of Group L being able to view or intercept their communication. This provides the members of Subgroup S with a level of privacy, separate from the larger group L. However, the members of the Subgroup S can also communicate freely with all the members of the larger group L, allowing them to meet new interesting people and forge new relationships and friendships. This hierarchy of groups can extend for multiple levels.

Related Groups

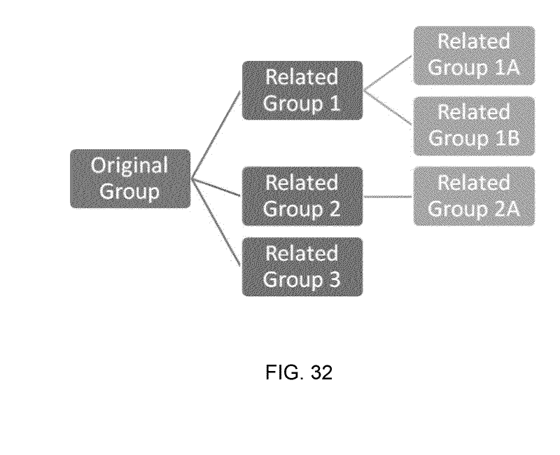

A group member of a single collaboration group can form a “related group” to the group they are currently a member. Upon forming the group, the user that formed the group can advertise the formation of the new group, including what the initial lead content will be. Depending on the group settings, users that subsequently join the group may also advertise the group to other users. A related group created from a group is called a child group while the original group is known as the parent group. Users can browse related groups, moving up and down the parent/child tree viewing current users and previewing the current lead in those groups. This effectively creates a social network of groups, which users (or subgroups) can navigate through in their search to find an interesting group. FIG. 32 is a schematic diagram that shows an abstraction of how one group could spawn multiple child related groups, and then those children groups can spawn additional child related groups of their own.

When forming a new collaboration group in the system, the new group is designated as a related group by default. Thus, when a new group is created from within another group, it is automatically designated a child group to the parent group, and inserted appropriately into the related group tree. When creating a group, however, users have the option of creating a private group. A private group is just like any other group, except that the relationship to the parent group is not stored, and the private group is not inserted into the related group tree. Thus, a private group will not show up as a child group to its parent group. However, in some implementations, a private group can have its own child groups, effectively creating a new family tree of related groups that is disconnected from the original parent group's family tree of related groups. In some implementations, the default behavior could be switched, such that private groups are the default and users must explicitly designate that a newly created group should be inserted into the related-group family tree.

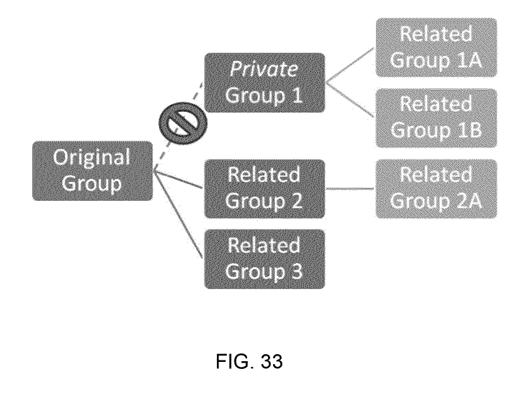

For example, FIG. 33 is a schematic that depicts an abstraction of how a private group relates to a parent group from which the private group was created. As shown in FIG. 33, “Private Group 1” is a private group, and its relationship to its parent, the “Original Group” has been severed. However, as shown in FIG. 33, “Private Group 1” has its own child groups (e.g., “Related Group 1A” and “Related Group 1B”), which show up in its family tree of related groups. While a user could navigate the related-group family tree from the “Original Group” down to “Related Group 2A”, there is no way for a user to navigate from the “Original Group” to the “Private Group 1” or its child groups (e.g., “Related Group 1A” and “Related group 1B”). To discover the “Private Group 1” and its corresponding child groups, a user must be given a GroupID (and thus a bootstrapping address) for “Private Group 1” or the children groups of “Private Group 1.”

Moderation Techniques

Moderation can be applied to groups, including subgroups. Before explaining how groups and subgroups handle moderation, some of the different states users (or subgroups) can possess are described.

a. Group Creator—The group creator is the individual who created a particular group. In the illustrated examples, there can only be one group creator. They are granted absolute power over the group in terms of moderating member activity in the group or setting group policies. They can ban or remove people from the group, remove user's lead abilities, chatting abilities, or web cam abilities, or remove moderator status, among other actions.

b. Moderator—The moderator is the second highest ranking an individual can achieve in a group. The group creator and/or moderators can grant or deny users the ability to perform leads, chat, broadcast over VoIP or webcams, among other moderating actions. Moderators can't affect or alter the capabilities of other moderators or the group creator.

c. Lead Ability—User can be granted the ability to lead other users in a group to content. Although all group members in the examples described above have the ability to lead to content or add content to a queue, Group Creators and/or moderators can revoke this functionality from other members in a group, thus limiting a group member's ability to serve content to the group. Such group members may therefore take a more passive, content-consumption role.

d. Web Cam Ability—Users can be granted the ability to stream video (e.g., from a web cam or a file) to the group.

e. Chat Ability—Users can be allowed to chat or muted, meaning that they can no longer communicate over text-based chat with the group.

f. VoIP Ability—User's can be allowed to communicate using VoIP or not.

Moderation by the group creator extends to all participants in his/her group. In the case of subgroups, the group creator (or his/her appointed moderators) can grant abilities, such as lead ability or chat ability, to the subgroups as a whole, or to individual members of the subgroup as they would any other member of their group. The benefit of bestowing abilities to a subgroup as a whole is that the group creator and/or moderators of the subgroup can then effectively moderate their subgroup members as they see fit. The group creator and/or moderator of a subgroup can extend to the subgroup members those abilities granted to the subgroup by the larger group's group creator and/or moderators. For example, referring to FIG. 31, if the group creator of the Group L bestows the subgroup S with the Chat Ability (e) but not the Lead Ability (c), then the Group Creator of the subgroup S can only extend the chat ability to his group members; nobody in the subgroup has the ability to lead. The Group Creator of subgroup S can, however, revoke the chat ability from any of these subgroup members as he/she sees fit.

Real-Time Search

Real-time searching can be used to rank content based on metrics gained through analysis of group interaction around the content, including text based keywords, user presence (i.e., availability in a group or online) metrics, lead metrics and social relevance. Text based keywords are derived from analysis of text chat around the content. Presence metrics include analysis of the number of users viewing the content over time. Lead metrics include the propensity of leads to that content and the viewing length of each of those leads. Lead relational metrics groups items as closely related when leads come in close proximity to one another in a group. Social relevance ranks leads by fellow group members and social peers higher than other content. Additional metrics and relationships can be derived from the group's communication and interaction around content.

Examples of Additional Features Present in Some Implementations

Groups can move between different services/features of the group collaboration system seamlessly. For example, a collaboration group service for sharing videos could provide a service for sharing web portals or images, allowing the same group to be led to videos, webpages, and images (e.g., photographs). Collaboration groups for viewing videos have been described in the examples above. Examples of other collaboration group applications, such as collaboration groups for web portals and images, are described below.

Web Portals—The group collaboration system allows users to form groups and co-browse to any site on the Internet. Similar to collaboration groups that allow users to view videos, users can also be led to content that includes a webpage. In some implementations, simultaneously presenting individualized versions of webpages can be difficult due to the presence of frame breakers that might be present for security reasons on certain sites (e.g., on Facebook). Additionally, in some implementations, the interface is cumbersome as a result of same origin policies (SOP). To overcome these issues, the web portal can be combined with a web extension to provide a hybrid solution.

Web Extension—To address technical difficulties of SOP in providing a smooth portal experience for the entire web, a browser extension can be used. For example, the collaboration group web extension allows groups to be formed around any website and individuals from those groups to lead from site to site all over the Internet. The collaboration group web extension may or may not interoperate with the bootstrapping mechanism of the collaboration group website. That is, since the web extension is embedded in the browser itself, it may not be necessary for a user to visit the group web page to view leads. Instead, the browser instance is essentially treated as a set of group web pages and is bound to the collaborative group system. For groups that do interoperate with the collaboration group website, clicking on the web address for the extension (e.g., LiveLead.com/foo where “foo” is a LiveLead Extension based group) would instruct the local plugin to join the group “foo” associated with the extension. The web extension simplifies the implementation of complex group-to-group interactions like Web conferencing and VoIP conferencing because the extension simplifies access to local hardware. The use of a web extension allows users to form groups for almost any website on the Internet, solving the SOP issue. Additionally, websites opting to participate in the collaboration group experience can grant permissions to the collaboration group system domain, allowing a smooth browsing experience on their websites without the need for a web extension. However, permissions would need to be granted on an individual basis; websites that do not offer these permissions will require the web extension for complete access to the collaboration group system capabilities.

Similar to other browser extensions, the web extension has access to content that is available to the browser itself. This includes, but is not limited to, the address bar, cookies, browser tabs, history, and the Document Object Module (DOM) of any webpage being viewed by the browser. It is this overarching view of the web browser that allows the web extension to overcome the SOP restrictions imposed on a purely web-page-based collaboration group implementation. Thus, the web extension can observe the DOM of the visited pages as well as the pages URI, something hidden from a web-page-based collaboration group implementation due to SOP.

The collaboration group web extension can be implemented in several ways. For example, the simplest way to overcome the SOP limitation is to use the web extension to augment the limitations of the web-page-based collaboration group. Thus, the user interface to the group collaboration system would still be web-page-based, requiring the user to first visit the system web site (e.g., LiveLeed.com) to load the graphical user interface (GUI). The extension would work closely with the web-page-based collaboration group to overcome the SOP limitation. The extension would be able to read the visited page's DOMs and determine their address (and any other necessary information), feeding it to the collaboration group web-page-based script, which, in turn, would use it to handle all user-interface aspects of the collaboration group web experience. For example, a web-page-based collaboration group interface (e.g., the collaboration group web portal), would open a new iframe (e.g., browsing iframe) for browsing external pages, while maintaining an iframe in the collaboration group's system domain for functionality (e.g., LiveLead iframe, where LiveLead is an example name for the collaboration group system). When a user visits a new external webpage in the browsing iframe, the extension (which is free of SOP limitations) can determine the page's address and then relay the necessary information to the iframe in the collaboration group's system domain (e.g., LiveLead iframe). Thus, when the user issues a lead to the external webpage being viewed in the browsing iframe, the LiveLead iframe can extract the appropriate information (such as the external webpage's URI) via the extension, and then issue the lead command to other members in the group. The benefits of this particular implementation are that the user interface can be designed once, as a web-page-based interface, working across all operating systems (OS) and browsers. The extension, which should be developed individually for each OS/browser combination, is very light-weight, requiring no graphical user interface and serving mostly as a communication layer between the LiveLead iframe and the browsing iframe. Since the extension serves as this communication mechanism, the extension can be rapidly developed for each OS/browser combination, relying on the LiveLead iframe to handle the user interface and group connectivity code.

Relying on the use of iframes (or some other similar mechanism) could suffer from web sites that employ iframe-breaking techniques, prohibiting webpages from being loaded in an iframe. These techniques could force the browser iframe to open in a new tab or window, instead of an iframe. While the extension could still serve as a communication mechanism between this new tab/window and the LiveLead iframe, the user experience may be hindered due to a more cumbersome interface, as the user interface is now in a separate tab/window from the external browsing content.

Another way to implement the web extension, which can overcome the iframe-breaking techniques, includes combining the functionality of the LiveLead iframe into the web extension. The browsing iframe no longer is an iframe, but just a normal tab/window, rendering the iframe-breaking issue a moot point. The web extension can then render a user interface overtop the browsing webpage, or integrated tightly into the browsers user interface. The benefit of this approach is that it will work on all webpages, even those employing iframe-breaking techniques. A potential downside may be that the extension requires individualized programming for every OS/browser combination. However, the user interface can potentially be much richer under this approach, as the limitations imposed on a web-page-based interface are no longer present.

When a user initiates a lead, the webpage identified as the content for the lead can be loaded automatically in an iframe, to load the page and display the content. Alternatively, when using a more complex web extension, the webpage identified as the content for the lead can be loaded in a browser window or new tab. The collaboration group web extension also can provide native video support, loading its own video player for playing online streaming video or video shared locally by users.

Webshots—Webshots allows a user to share an offline version of a webpage with other members of the group. A webshot is different than screen sharing or leading the group to the online version of the webpage.

In the case of screen sharing, the group members can only see what the leader is currently looking at. If the webpage requires scrolling to view all its content, the other group members can't see any section of the page they desire. Rather, they are limited to the section of the page that the screen sharer happens to currently be viewing. It is like watching the screen sharer browse the web by looking over their shoulder at the computer screen. Group members could see what he/she sees, but have no way to influence the content without asking the screen sharer to do so.

In the case of leading the group to the webpage, the lead actually takes them to the webpage, such that each group members' individual computer loads the web content. In this way, the group members can observe the content themselves, since they are actually at the webpage too. All group members are at the same webpage, but they are all there individually, on their own computers. If the webpage contains certain authentication requirements, and some of the group members don't meet these requirements, then they will not be able to see the webpage the same as those who do meet the authentication requirements. For example, consider a social network where the user leads the group to one of his/her friend's webpages. If this friend's webpage only allows other friends to view it, then those members of the group who aren't friends with that person in that social network will not be able to see the friend's webpage, even while the group leader (and other members of the group who might be friends on that social network) can view the page. Another example would be a web forum requiring a user account to view the posts. If members of the group don't have accounts at this web forum web site, then they won't be able to see the web sites group members lead them to within this web forum's domain.

Webshots overcomes this limitation by allowing the user to send (or ‘shoot’) an offline copy of the webpage to members of the group. Upon receiving the webshot, the group members can reconstruct the webpage (in an offline manner) and view the page at their leisure. This can be accomplished in a few ways. In some implementations, a user takes a screen shot of the webpage, and then sends the image to the other members of the group. However, this approach may suffer from a similar limitation imposed on screen sharing: if the webpage requires scrolling to see all the content, only the content currently on the webshooter's screen is captured with a screen shot. Thus, the other group members can only see a portion of the webpage. Nevertheless, this can be useful if the webshooter wishes to limit the visible content shared with the group. A more powerful solution is to actually extract the webpage and its content, building an offline version of the page, and then send (i.e., webshoot) the reconstructed version to the other group members. This is accomplished by crawling the target webpage's DOM, extracting any content (such as images) embedded in the webpage, and then rebuilding the webpage as an offline version. The offline version can then be sent to the other group members, who can open it like any other webpage. Other group members can then see the entire webpage as if they were actually visiting it online. If the page requires scrolling to see all its content, the other group members can scroll through the page and view all this content. Links in this offline-version of the webpage resolve to their online counterpart. Returning to our previous social network example, if the other group clicks a link in the offline webshots version, the link will take them to the appropriate online page. If the user doesn't have access to the online version of the page, the user will not be able to view the page, requiring someone with access to send them another webshot if they wish to view the page. In this way, webshots allows group members to experience webpages explicitly granted to them by someone with access to that page. However, if links in the offline webshot version of the webpage resolve to an online page that a user does have access to, then the user will be able to follow the link and view the page.

Because SOP may prohibit a domain to view the DOM of another domain, the webshots may only work with the web extension, potentially being a subcomponent of it.

However, it is possible that different domains could grant access to their DOM, enabling the use of webshots without an extension for such pages.

Photographs/Image Documents

Online photographs and other images can be typically stored locally on a client device or with a third party server such as those operated by social network applications including, for example, Facebook, Flickr, or Picassa. The collaboration group system allows synchronous real-time photo viewing amongst group members. A user can simply connect through their corresponding social network login and can browse and share their photos just as they would videos or webpages. New users can be invited to the viewing through the standard sharing of the collaboration group's bootstrap address. The full session of presenting a set of photos can be stored and then replayed at a later date. Photos can also be led by overlaying them over other content, such as videos or webpages, allowing group members to see the photo quickly without completely leading away from the previous content. In the case of videos, this allows the video content to continue playing while the photo is shown; not only does this prevent complete interruption of the video viewing experience, allowing someone to quickly show a group photo relevant to the video, in the case of music videos, it allows for slideshows set to music.

Mixed Content

Mixed content refers to the fact that the collaboration group isn't limited to viewing a single piece of content at a time. Just as in the previous photo example, photos could be overlaid on top of existing content (such as video or web page), in some implementations, it is possible for multiple videos to be led to at the same time and simultaneously displayed. For contents with disjoint components, such as content with a visual component and content with an auditory component, this concept is more obvious. For example, a user could lead to music. While the music is playing, he/she or other users could then lead to visual content, such as photos, videos, or web pages. In another example, users could lead to pod casts, allowing the group to listen to the podcast together. While listening to the podcast, the group could continue to lead to relevant content, such as web pages, without interrupting the audio podcast. While the use cases of mixed content are most obvious for complementary audio and video components, it can be applied to content that have competing components. For example, while leading around web pages, complimentary video leads could appear as hovering panes, overlaid on top of the web page, or even in an unobtrusive area of the lead space, such as the lower right-hand corner. In this way, the leads to such complimentary videos don't completely upset the main lead content, in this case, the web page. The point here is that, ultimately, the collaboration group isn't limited to viewing a single piece of content at a time.

Collaboration Groups for Ecommerce

Collaboration groups for ecommerce are specific web-based portals that use the collaboration group technology with ecommerce websites (e.g., eBay, Amazon.com, or Craigslist). Because of SOP, the collaboration group system will have to make use of these websites application programming interfaces (API) (or some other mechanism, like caching and serving the content) to enable users to perform leads around their content/products. This can facilitate group shopping while allowing each individual user to purchase the items on their own computer (since they are actually at the site, and not performing screen sharing).

Collaboration Group Maps

In some implementations, the collaboration group system also allows multiple users to synchronously browse a map by synchronizing as leads the Javascript commands that pan, zoom, and change modes of the map website. Other map-specific rich features can also be included, such as, for example, leading to route information, directions, or different views (e.g., satellite vs. street view).

Collaboration Group Forms

In some implementations, the collaboration group system can also facilitate the remote filling of website forms. For example, a user may lead the group to a website where a form must be filled out to proceed. The group leader, having already filled out the form, may automatically fill-out the forms for the other group members with only a click of a button. For example, Bob may create a small group for himself and his grandmother, Alice, to help her sign up for some web service. Bob can lead Alice to the appropriate website, and then teach her to fill out the forms by doing so himself; then, by clicking a ‘form lead’ button, Bob can cause the form on Alice's computer to be filled out in a similar manner, easing the process for Alice and teaching her how to sign up for the web service.

Group Laser Pointers

Group members can point to specific areas in the lead content using multi-colored and/or multi-shaped indicators, allowing them to specifically identify, for example, portions of photos, documents, videos, or web pages,. The different pointer's colors and/or shapes can be used to indicate which user is controlling that particular pointer. This pointing mechanism can be extended to other features including, for example, drawing, allowing users to circle, or highlight, various sections of the lead content as well as clear their individual markup.

Collaboration Groups for the Business Processes

In some implementations, business application software, such as Powerpoint, Word, Excel, and PDF documents, can also be made available for leads. Similar to Google Docs, collboration groups can collaborate around these documents. Unlike Google Docs, however, group members can lead their groups to new content; the group isn't defined by a single document. The collaboration group system can be configured to include functionality that allows recording and playing back presentations, thus providing a new, robust mechanism of first creating and then giving a presentation.

Content in General

Various examples of content to which a lead, seek or synchronization can be performed are described above. For the purposes of this disclosure, content is not limited to simply document files, video files, audio files, or image files. For example, as explained above, users of the collaboration group system can lead to other groups or sub groups formed within the collaboration group system. In some implementations, leads, seeks, or synchronization can be performed on a pre-packaged series of leads (e.g., a playlist or ‘folder’ of content). In some implementations, leads, seeks, or synchronization can be performed on binary files or files that contain software executable code. Various other types of content can be used as well.

Location-Aware, Group-Connection Mechanism

Location-aware, group-connection mechanism (LGM) is a mechanism to facilitate the easy connection to collaboration groups when the client devices used by group members are in close geographic proximity to one another. As previously discussed, group connection can occur over numerous mediums using the unique GroupID, such as, for example, URLs, emails, IMs, SMS/MMS, IR, RFIDs, QR codes, social networks, GPS and/or synchronous events,. The purpose behind LGM is to make this process even easier and more seamless for the case of connecting to a group of devices that are in close proximity. We are simplifying the process of walking up to a device and immediately and effortlessly joining to that device's group.

This concept can best be described with some examples. For instance, consider a situation where a person (host) is throwing a party. The host may use their web-enabled TV or desktop computer connected to a sound system to provide music for the party. Using their client device connected to the collaboration group system, the host can form a group specifically for the party. When their guests arrive, the host could employ their smartphones or tablets to connect to the newly created group and participate in the group's shared music playlist. In some implementations, the host can apply previously described access control policies, preventing guests from performing leads and limiting their contributions to additions to the shared playlist. Similarly, the host could send out a mass email or SMS message to the party guests informing them of the availability of the collaboration group and including an clickable link to join the collaboration group and participate.

What LGM contributes is a more natural mechanism for party guests to join the group and participate. For example, in some implementations, the GroupID can be advertised over the local WiFi SSID, allowing guests to simply ‘scan’ for the group, find it, and join it, without requiring the mass invitation. In light of the guests' proximity to the WiFi network on which the primary device operates, the guests can find and join the group. Additionally, the guests' smartphones' global positioning system (GPS) application can be invoked, allowing the ‘scan’ feature to operate based on physical location; when scanning for a nearby group to join, the host's group would appear and guests could connect and contribute. Other mechanisms work especially well for this scenario, including RFIDs and Bluetooth (which can be detected in close proximity), QR codes (which can be placed around the party or on the primary devices screen and scanned by anyone wishing to join the group), simultaneous events correlated with physical locations (such as users pressing a connect button, bumping their phones, or even emitting specialized frequencies), and many more. Participation in the party's group need not be limited to individuals at the party. For example, people who could not be present can still connect to the group using other, previously described mechanisms for sharing GroupIDs (e.g., bootstrap addresses). Of course, the host can limit participation to those guests that are physically present at the party by adjusting the policies of the newly created collaboration group. This policy can be enforced based on the guests' reported locations (e.g., from the guests' GPS software or cell phone tracking applications). In some implementations, the host may personally authenticate each individual that submits a request to join the group. Alternatively, or in addition, the host may specify an authenticated guest list, or allow everybody within a specified geographic location to participate. Participation in the group could also be limited based on time. For example, guests that have joined the collaboration group may be prohibited from controlling the host's sounds system after the party has terminated or after a specified period of time.

In another example, a group of friends meets for lunch and desires to share their most recent vacation or family photos. By using any of the previously described LGM mechanisms, these friends can easily and effortlessly form a collaboration group that leads each friend to the various photos the friend make available from their client device (e.g., smartphones and/or tablets) or from a third party server coupled to the Internet. In this way, the group of friends can share their photos without having to crowd around a single person's device, watching from the comfort of their own seat on their individual devices. In the instance they were having lunch at one of their houses, the owner's TV or desktop computer could be used as a public viewing screen that the friends could use to show their photos to the group.

In another example, a group of friends meets up in the city to go out for drinks Upon meeting in the bar, the friends can use the LGM service to form a cohesive group. They can communicate, share pictures and videos taken that night with the group, including location information about where the photo or video was taken. The users can locate other group members should any of them get separated. The collaboration group system can provide to one or more group members GPS-style directions on how to physically find the other group members (or location where photo/video was taken), regardless of whether the users are in close proximity or relatively far apart.

The LGM service also does not require multiple users. Instead, the LGM service can be used by a single individual to connect and control multiple devices. For example, a user could create a home entertainment group, easily connect his smartphone/tablet to his various multimedia devices, and control them individually or as a synchronous system, simultaneously leading to content on all devices. In an example implementation, a user can throw a party with multiple video screens to which the many guests can contribute content, which is then displayed simultaneously on all devices that are part of the collaboration group.

Now that the concept of LGM has been explained, we will delve further into how LGM can technically be achieved. One simple way to realize LGM is through the use of Quick Response (QR) codes. QR codes contain a large amount of information in a compressed visual square that is captured by a camera and scanned by a computer. LGM can be realized through QR codes by providing a button (or link) within any given group that will generate and display a QR code for that group. A user in the group would click the link, and this would result in a QR code that could be then displayed on the device's screen or printed off and pasted near the device (or around the house/bar/apartment where the group is operating). In this way, a user can quickly connect their device to the group by simply scanning the QR code. Most mobile devices already have QR code scanners, and so, as a simple implementation, the QR code for LGM can contain the group's bootstrap address, making it easy for any existing QR code reader to read the code and then join the group by loading the bootstrap address in their device's local browser. As mentioned, these QR codes could be printed off and left around the bar/house/apartment, or they could be displayed on the screen of the device themselves. When displaying on the device's screen, it could be used to connect several mobile devices, such as smartphones or tablets. The user hosting the ad-hoc group could click a button to generate the group's bootstrap address encoded in a QR code; this QR code would then be displayed on his/her smartphone/tablet, where other users could scan it with their mobile device's camera, seamlessly joining the group. Another way to realize LGM is through the use of Bluetooth. Devices that are already part of the group could advertise the group's bootstrap address over Bluetooth to other nearby devices. This would require the users wishing to join the group to pair with the device advertising the group over Bluetooth. After the quick pairing process, the new device would be informed of the group's bootstrap address, which it could join. There are two ways to realize LGM over WiFi. The first involves the user actually joining the WiFi network, and once on the network, joining the local network's sharing service (e.g., SMB), which could then alert it to the group's bootstrapping address. The other involves the manipulation of the WiFi access point's SSID. In this scenario, the devices could have a different way to connect to the Internet (though, it could also be through the WiFi access point). The device advertising the local group would use its WiFi card to generate an ad-hoc network, setting the group's bootstrap address as the SSID field. In this way, new client devices near the advertising device would scan for local WiFi networks within range. Upon discovering WiFi networks with SSIDs describing groups' bootstrapping addresses, it could inform the client of the nearby collaboration groups which he/she could join. Connecting to these groups would cause the client device to join the group, either over another Internet connection (such as a smartphone's 3G connection, or another WiFi access point) or over the WiFi connection being used to broadcast the group bootstrapping address. Another way to realize LGM, is to make use of the devices actual physical location. In this manner, devices advertising their group's bootstrapping address would do so based on their location as well, with some range (either user-defined or chosen based on the size of the group, geographic location, etc). For example, a desktop computer at latitude X and longitude Y could advertise its group to be accessible to nearby devices with Z meters of its location. Thus, any GPS-enabled device that is within range could be alerted of the nearby group, perhaps listing the current members, current content, etc. The users could then choose to connect and join that group, assuming the group creator and/or moderators have given them access. This process of joining physically close devices via GPS coordinates can be further simplified by augmenting it with simultaneous events. In such an instance, a device advertising a group (based on, for example, X,Y coordinates) and a device wishing to join a nearby group could use simultaneous events to ‘find’ each other. In this case, the device wishing to join the group wouldn't have to scan for nearby groups and then select one. Rather, it could simply walk up to the device known to be hosting a group, and perform a synchronous event with it. Synchronous events could include shaking your phones at the same time, or bumping them together. It could include clicking a button (such as the spacebar, or enter, or a number/button on your smartphone) at the same time. Because the two devices performed some even together, and they are in the same geographic location, the servers would be able to determine that the two devices wish to join groups, and the new client device would be informed of the appropriate group's bootstrap address to join.

Another way to realize LGM is through the use of sound frequencies. The device advertising the group to join could emit a specialized sound (possibly outside of the frequencies humans can detect), which other devices could detect, and which contains, encoded within it, the bootstrap address. This sound could be emitted constantly or could be emitted on demand; the device wishing to advertise the group's bootstrap address would have a broadcast button (or some similar mechanism), causing the device to emit the necessary sound. Alternatively, the sound need not have the bootstrap address encoded it. It could be used as the synchronous event in our previous example. This could allow many devices in close proximity to join an advertising device at the same time. For example, the device advertising the bootstrap address would emit some specialized sound, and all the client devices wishing to join would detect that sound. Upon detecting the sound, and knowing their geographic location is within range of the advertising device, the servers could determine which devices were attempting to join the advertising device's group and inform them of the group's bootstrap address.

Bookmarks/Favorites

In some implementations, the collaboration group system allows users to save and organize content they have discovered to their personal profile. The content then can be recalled for later use, including, for example, to lead and show other group members within the collaboration group system.

There are many ways that a user can discover new content in the collaboration group system. For example, a user can be led to that content by other group members, a user can view a group's Lead History or Playlist, or a user can search for content within the group collaboration system (e.g., searching for videos). The bookmarks/favorites can be implemented using a single icon or button. Upon selecting the icon/button, the content identified by the user can be saved to their corresponding collaboration group profile. This saved content can be organized through a tagging system, allowing users to cluster together similar content, form music playlist and photo albums, among other content.

The tagging system allows for multiple tags per item. For example, a funny music video could be tagged as ‘funny’, ‘music’, and ‘Jeff’, assuming the user's friend Jeff introduced him/her to the content. The content stored in a user's bookmarks/favorites profile can be searched and filtered in real time, allowing users to quickly find content with a certain title or tag. Continuing with the previous example, the user could quickly find content Jeff has shown the user or quickly pull up music videos from the profile to add to a group Playlist. The bookmarks/favorites link operates by storing to the user's profile a reference to the actual content. The bookmark/favorite feature can extend to most online content, including, for example, online videos, streaming videos, online photo albums, and/or webpages. The bookmark/favorite feature can apply to cloud storage systems, such as Google Drive, DropBox, Apple's iCloud, or a cloud service associated with the group collaboration system. Using the sharing permissions with each such service, users can protect their content from being re-shared to other users that they don't approve. If a user adds a local file (e.g., a file stored locally on a client device operated by the user) as a bookmark/favorite, the local file can be synchronized and uploaded to an online, content-storage system. Then a URI to that content can be saved as part of the user's profile. Similarly, if a user leads to a local file, the local file can be synchronized and uploaded to an online, storage-content system, allowing other group members to view the content. The other group members then can use the bookmark/favorite link to save a reference to the local file if the group member's permissions (set, e.g., by the moderator and/or group creator) allow. Accordingly, content can be readily shared using the reference, and users do not have to transfer the actual content to multiple people in a collaboration group.

The use of a bookmarks/favorites link adds a powerful organizational mechanism for both discovering and sharing new content. Users can take all content categorized as a bookmark/favorite under a tag specified by the user and load the content into a group playlist, allowing playlist generation to occur much more quickly. Additionally, users can share bookmarks/favorites with other users based on tags or search results. For example, a user could search/filter the user's bookmarks/favorites containing the words “Michael Jackson,” and load the results of the search into a playlist, share the results with a friend, or recommend the results to friend. Similarly, bookmark/favorite filters could be used to make certain bookmarks/favorites publicly available to other users. For instance, a user can make content contained within their bookmarks/favorites profile that is tagged with a specified term (e.g., “public music”) available for viewing, saving, or leading. The content can be made available to any other user in the group collaboration system.

The availability of the shared bookmarks/favorites content can be tailored according to a user's personal preference. For example, a user can set his profile to allow only the user's Facebook friends to view the user's bookmarks/favorites tagged with the term ‘facebook travel videos’. In another implementation, a user can specify individuals who are not allowed to access the shared bookmarks/favorite, and therefore prevent those individuals from viewing or accessing the content. For example, a user may wish to prevent the user's family members from viewing photographs obtained at a concert event. If the photos are stored as bookmarks/favorites, the user can tag those photos with a particular name and restrict their family members from accessing the tagged content.

The process of saving bookmarks/favorites or re-tagging bookmarks/favorites can be done in many different ways. For instance, a user can save and tag items on an individual basis, as might be the case when a user leads another group member to a single video. Alternatively, in some implementations, entire groups of videos can be saved and tagged. For example, if the user “Jeff” shared his playlist ‘country music’ with his friend “Sarah,” the collaboration group system allows Sarah to immediately browse Jeff's shared content. Sarah can further choose to accept all the shared content tagged as ‘country music’ into her bookmarks/favorites. Any content contained in Jeff's ‘country music’ bookmarks/favorites that Sarah already had saved would simply have the additional tag of ‘country music’ applied to them, maintaining her existing organizational structure while still allowing her to find the videos shared by Jeff Any new videos Jeff shared would have their references saved to Sarah's bookmarks/favorites and be tagged as ‘country music’. If Sarah already has a ‘country music’ tag, a dialogue box can be displayed that provides Sarah with the option to rename the tag (perhaps with a unique suggestion by the system, such as jeff—country music') or merge Jeff's ‘country music’ with her own.

A similar process can be applied to shared Playlists and Lead Histories as well, allowing a user to save the mass content to the user's bookmarks/favorites and append a descriptive tag in a single step. Sets of items can be added to bookmarks/favorites and tagged in bulk in other ways as well. For example, the user can select multiple items in a search result, or the user can select a subset of the Lead History. Adding new tags or re-tagging existing items in the bookmarks/favorites can be accomplished in a similar manner. A user can search for an existing tag, such as ‘hip hop’, and then rename that tag ‘rap’. Alternatively, the user can add a new tag to some (or all of the content), such as ‘90s hip hop’.

The bookmark/favorite feature also facilitates interesting group dynamics. For example, imagine a user hosting a party and using a collaboration group to provide music to which the guests can contribute. Guests can use the bookmark/favorites access control and tagging mechanism to make certain music ‘playlists’ available and shared with the host's party group. In some implementations, the guest can put a time limit on when the shared playlists are available for the group to view and lead around, limiting access to them to the evening of the party. As a result, guests can contribute to the music selection without overtly injecting new music into the shared Playlist. In some cases, the host can have a dedicated DJ who then keeps the party's music going based on the guests' shared tags (or playlists). The host can set the group's access control so that only the DJ can lead, and thus the guests can only contribute to the party's music through their ‘suggested’ music in the form of their shared bookmarks/favorite tags. This is similar to a DJ taking requests at a wedding, only much more powerful as the guests can contribute large quantities of music, providing the DJ with a much richer source of content to choose from. In addition, because the guests ‘suggestions’ are bookmarks/favorites in the collaboration group system, they include the references to the actual content, ensuring that the DJ actually can play the music, instead of having to turn down suggestions because of his/her inadequate music library. Continuing with this example, the guests could then even be permitted to save the music that the DJ played at the party the next day to their bookmarks/favorites. Returning to host's collaboration group, they could save some (or all) of the songs in the History to their personal bookmarks/favorites, perhaps tagging them with a description relevant to the party (e.g., ‘Rick and Linda's wedding’).

Automatic Imports

Automatic imports is a mechanism for quickly and effortlessly adding massive quantities of existing content to one's bookmarks/favorites. Existing content, or list of content, is fed to the collaboration group system, which then crawls the web discovering online versions of the content with references that can be saved to the user's bookmarks/favorites with a descriptive tag. For example, a user can select photos from Facebook, Flickr, or Picassa. The collaboration group system enables the user to tag the imported content and save all the references to the user's bookmarks/favorites for sharing or viewing at a later time.

Offline sources, such as a user's iTunes library, can also be used as an input source. The user's songs can be discovered in a free online variant, tagged by the user, and stored into the system, preserving any existing iTunes tags if desired. If a free online version is not available, the user can upload their purchased content to a cloud service, and from there it can be referenced and saved to the bookmarks/favorites. Similarly, if a user wishes to add an entire album or artist's discography, simply entering the album or artist would use online databases to determine the constituent songs. Again, freely available online versions of these songs would be discovered on the Internet if available, and their references then can be added to the user's bookmarks/favorites. If free, online versions are not available, the user could be prompted with the option of purchasing the music.

Another example source includes radio stations' online RSS feeds of music. Users can enter into the browser which radio station they like and can include specific information such as a certain day. The songs played on that day can be automatically located, tagged, and stored to their bookmarks/favorites. Lastly, automatic audio song recognition provides an interesting example for how this technology could be used. If a user were to hear a song he/she enjoyed, they could use an automatic identification system (e.g., a system that ‘listens’ to a few seconds of the song and then identifies it, such as Shazam) to determine the song title, artist, and album. The song, artist, or album could then be tagged and instantly added to their bookmarks/favorites where they can then lead to it or share it with friends.

Recommendations

Recommendations allow for a collaboration group user to recommend discovered content to another group member or to a contact not in the collaboration group system. This can be done on an individual or on a group basis, both in terms of content and the targets of the recommendations.

For example, a user that discovers a new music video in the collaboration group system can recommend the music video to a single friend or to multiple friends. This recommendation can be sent from the collaboration group system, alerting the users (e.g., by email, by instant message, or via a message sent to the user the next time the user is logged into the collaboration group system) of the recommended content. The recommendation can include an offer to tag and save the content to the user's bookmarks/favorites. If a user is not logged into the collaboration group system, other communication mechanisms can be used. For example, a message can be posted to a user's social network “wall” (e.g., a Facebook wall) or sent using another communication application (e.g., Twitter or e-mail). Users who are logged into the collaboration group system can be alerted using those alternative communication mechanisms as well.

When a user logs into the collaboration group system, the user's recommendations are displayed and organized by who recommended them. They can be searched by the user who performed the recommendation, by the titles, by tags, among other features. Users can then examine the recommendations, lead other groups to them, tag them and/or save them to their bookmarks/favorites. Content can also be recommended in bulk. For example, a user can be allowed to recommend entire music or photo albums (or a combination of the two for an interesting slideshow) to a single friend or multiple friends. Aggregating content for recommendation purposes is an easy operation thanks to bookmarks/favorites and the tagging mechanism. For example, users could perform a search/filter of their bookmarks/favorites for all items tagged ‘Led Zeppelin’, and then recommend that content group to any number of friends. Additionally, a user could perform a more complicated search such as ‘Led Zeppelin’, ‘Pink Floyd’, and ‘Bruce Springsteen’, to quickly recommend a series of albums to any number of friends. Users receiving these recommendations have the option to save any portion of them to their own bookmarks/favorites under the provided tag, or a new tag, as previously described when a user saves a shared ‘playlist’ or a set of content from the Lead History.

The differences between sharing and recommending content can seem subtle, but there is a clear distinction. Sharing content with a user (or group of users) makes that content available to the user to view in a passive manner. The user with whom the content has been shared can browse the sharing user's content, look at it, and choose to lead or save it to their personal bookmarks/favorites. Recommending content, on the other hand, is a much more active process. The individual recommending the content actually ‘pushes’ it to the other user (or group of users). The user who is receiving the recommendation will typically receive an alert (e.g., an e-mail or instant message) and, in some implementations, be reminded of their recent recommendations upon logging into the system. It is similar to calling a friend or group of friends and telling them how much you enjoyed a movie and how you think they would enjoy it too. Meanwhile, sharing is more akin to a friend coming over to one's house and observing his/her DVD collection, which has been left publically available to visitors; this friend may find some DVDs interesting, and ask to borrow them, but was never explicitly told by the host to check out a certain movie.

Lastly, it should be noted that sharing, as a much more passive operation, can be done with everyone in the collaboration group system. An individual may choose to make all their content tagged ‘rock music’ available to the entire collaboration group community (e.g., through a concise, unique ID which can be shared in anyway a GroupID, or bootstrapping address, can be shared/advertised) to listen to, lead to, and save to their own bookmarks/favorites. However, a user may never recommend an item (or set of tagged items) to the entire community—such a spamming action would not be appropriate or productive.

Friend Linking

This is a mechanism to add newly discovered friends from collaboration groups to various external social networks and online contacts (e.g., Facebook friends, Google contacts, etc). When in a collaboration group with other users, there is a simple option next to their name allowing them to be added to one's other social networks and contacts (i.e., if they are not already added). For example, imagine three individuals, Jeff, Tom, and Steve. Suppose Jeff and Tom are both friends with Steve, but have never met each other in real life or online. By virtue of being friends with Steve, they one day find themselves in a collaboration group with Steve, where they quickly discover that they have very similar tastes in music and online videos. If both are on Facebook, Jeff and Tom can easily send each other Facebook friend requests from within the collaboration group system with a single click. Likewise, they could, with a single click, add each other's contact information (e.g., phone numbers, emails, address, etc) to their individual online contact database, which could then be synced with their phones, etc. In another example, Jeff and Tom could have met in a public collaboration group, never having a friend in common. The process of friend linking can be extended to groups and subgroups, allowing a user to quickly add all the new and interesting people he/she discovered while hanging out in a collaboration group. In this way, friend linking is a simple and natural way to build new online connections with individuals (or groups of individuals) discovered in online collaboration groups.

Collaboration Group Premium Content Store

In some implementations, the collaboration group system can include a virtual marketplace for digital items that may be purchased and used by individuals or groups. The purchase itself may be made by an individual or a group of users. The purchase may be made by subscription, per content payment, or a crowd-source payment where the content or application is released when a threshold amount is reached in funding. What differentiates the collaboration group content store from traditional application stores such as Google Play or the Apple App Store is that the collaboration group content store sells digital items that are designed to support groups in both sale and use. Digital items in the collaboration group content store are sold with Group digital rights management (DRM) that specifies who, what, when and how content that can be accessed.

Group Digital Rights Management is traditional DRM with additional rules related to Groups. Group DRM policies on content can cover a wide and versatile spectrum of permissions, ranging from completely open access to severely restricted access, depending on the content owner/seller's individual needs and desires. For example, an item purchased with Group DRM may contain a rule that the purchasing owner may lead the item to a maximum of 5 friends at a time, and none of those friends may save, bookmark/favorite, or lead to that item again. Another Group DRM rule may specify that content may be bookmarked/favorited and led to (but not saved) only by the purchasing user, friends of the purchasing user and friends-of-friends but no one else. This rule significantly encourages viewers to become friends with and closely follow content owners, which, in turn, encourages the creation and sale of content. When using the previously described ‘Recommendations’ for Group DRM content, the recommended content can be introduced with new, proactive permissions for exposure to the new user. For example, it can be available to the user for a limited time, in part (e.g., as a preview, or the first few minutes/seconds), or as a link to a store where the user can purchase the content themselves, at a discount (perhaps with a reference code crediting the user who recommended the content), or with another group. As a result of Group DRM, a group-based commerce eco-system can spring up around content.

Persistent Groups

Groups by default are persistent, requiring the creator to explicitly delete them. This is done by design, as the presence of persistent groups can give rise to powerful asynchronous group interactions. Thus far, the primary focus of the collaboration group system has been the real-time aspect relating to leading around content in a group setting.

However, to form a real-time group requires accurate timing, and not everyone can be available when groups of friends organically form. While public groups with strangers might not have this problem (since like-minded strangers will likely be aggregating, e.g., to kill time in public groups), the case for more personal, private groups among friends may suffer this shortcoming.

The persistent nature of groups helps to alleviate the foregoing problem. If a user cannot partake in a group of friends' real-time experience on the collaboration group system, that user has the option of stopping by the group at a later date and reviewing the Lead History (depending on the group's access control settings). Alternatively, or in addition, the user can review parts of the conversation the group creator and/or moderators choose to leave persistent, thus making the real-time chat analogous to the familiar asynchronous posting mechanism popular on many sites. Accordingly, the tardy user is provided with a sense of connection to the previously active collaboration group, and when next the user can meet and hang out with them, he/she can contribute to any conversation relevant to the group session he/she previously missed. In fact, when joining a group, users can be alerted (through unobtrusive visual cues) as to which content (be it leads or chat messages) are new since the last time they were active in the group. These ‘new flags’ can allow the latecomer to quickly catch up on the lead content and the conversation. In addition, the persistent nature of groups can be used explicitly as an asynchronous communication and content sharing mechanism, similar to many existing post-and-respond systems. For example, if a group of friends' hectic lives prohibit them from ever synchronizing in a real-time collaboration group, the friends can use a group's persistent nature to asynchronously communicate, sharing content (e.g., videos, photos, articles, or webpages,) that the friends think other members of the group might enjoy. Each member of the group can visit the group webpage at their leisure and see what the group has been talking about. This is very much like existing message boards, with the exception that if two or more users arrive during the same time, they can suddenly engage in a real-time conversation around content, making the experience much more lively and fulfilling.

Collaboration Group Metrics

The collaboration group system can, in some implementations, providing statistics associated with the collaboration group system to other websites and domains. These statistics include, but are not limited to, information such as who led the group to content, the size of the group, and how many leads each user has conducted. These metrics can be made available to other websites as is appropriate (e.g., based on what the destinations intend to use the statistics for and the privacy settings of individual users in the group). Depending on the needs of the site and the users privacy settings, this information can be anonymous or not (e.g., it might not be anonymous if the user wants credit for certain actions he/she has done within the group). In an example, collaboration group metrics can be used with an ecommerce site. An ecommerce site may wish to know which user of the group led the group to their site and/or product. Furthermore, the ecommerce site may be interested in how many members of the group then purchased said product or products on their site. The ecommerce site might also be curious as to how long the group members spend on their site, which products the group members lingered on the most, among other things. All of this information can be used by the ecommerce site to improve the site's online experience to customers. The ecommerce site can also use the metrics to promote sales, for example, by granting benefits or rewards to group members who purchase products. The ecommerce site can also grant benefits to the user who led the group to their site. In some implementations, the ecommerce site can add a weighting to the benefit/rewards based on the number of users who purchased items on the site, the amount of products purchased, among other details.

In another example, a producer of a television show can use the metrics to do a promotion or a competition, where the producer rewards users for spending time on a web site associated with the show, or for bringing other users to the web site. This same approach applies to other content besides web sites. For example, a musician may want to promote a new album by having a competition to see how many people fans can lead to their new, online music video.

III. Functional Operations and Implementations

Various aspects of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback;

and input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the invention. Accordingly, other implementations are within the scope of the following claims.

What is claimed is:

1. An on-line system that allows a group of people to interact around common content, the system comprising:
a computer network;
a server system coupled to the computer network; and
a plurality of user devices, each of which is coupled to the computer network and each of which is associated with a respective member of the group,
wherein the server system stores identification information for each member of the group,
wherein, in response to receiving a lead to content initiated by a member of the group, the server system sends a reference to the content to the respective user devices of the other members of the group, and
wherein, in response to receiving the reference to the content, at least some of the user devices automatically access and load the content via the network.

2. The system of claim 1, wherein the content is selected from the group consisting of a video file, a document file, an image file, an audio file, a webpage and combinations thereof.

3. The system of claim 1, wherein, in response to receiving the lead to the content, the server system causes each of said at least some of the user devices to each access and load the content beginning at the same portion of the content.

4. The system of claim 1, wherein, in response to receiving a seek command from a first user device, the system causes each of one or more other user devices to access the content beginning at the same portion that currently is being accessed by the first user device.

5. The system of claim 1, wherein in response to receiving a synchronize command from a first user device, the server system causes the first user device to access the content beginning at the same portion that is being accessed by another one of the user devices.

6. The system of claim 1, wherein in response to receiving a related content request issued by a first user device, the server system provides to the first user device a collection of different content, wherein the collection of different content is selected based on a feature of the referenced content.

7. The system of claim 1, wherein in response to receiving the reference to the content, at least some of the user devices automatically access and load individually accessible and identical versions of the content via the network.

8. The system of claim 1, wherein in response to receiving an invite initiated by a first user device among the plurality of user devices, the server system sends an invite message to one or more user devices not associated with a member of the group.

9. The system of claim 1, wherein the identification information for each member of the group comprises individual member identification information and group identification information.

10. The system of claim 1, wherein the server system is configured to:
store content in a playlist queue accessible by each of the user devices; and
cause at least some of the user devices to sequentially access and load the stored content.

11. The system of claim 10, wherein the group of people corresponds to a first group that is a subset of a second group, and wherein the system, in response to receiving the lead to content initiated by the member of the first group, sends the reference to the content to one or more user devices associated with members of the second group, and wherein, in response to receiving the reference to the content, the one or more user devices associated with members of the second group automatically access and load the content via the network.

12. The system of claim 1, wherein the reference to content comprises information about the identity of the member that initiated the lead to content, and wherein, in response to receiving the reference to content, at least some of the user devices display the information about the identity of the member that initiated the lead to content.

13. The system of claim 1, wherein the at least some user devices automatically access and load the content within a page of an Internet browser in response to receiving the reference to the content.

14. The system of claim 13, wherein the server system is configured to receive data from a first user device and relay the data in real-time to the respective user devices of the other members of the group, wherein the user devices, upon receiving the data, cause the data to be displayed within the page of the Internet browser.

15. The system of claim 1, wherein the server system is configured to:
store a history of content accessed by the plurality of user devices; and
send the history to the respective user devices of the members of the group.

16. A machine-implemented method of allowing a group of people to interact around common content, the method comprising:
receiving, at a server device, a lead to content, wherein the lead is received from a first user device associated with a member of the group;
sending from the server device, over a network, a reference to the content to one or more respective second user devices of other members of the group, wherein the reference to the content comprises instructions to cause each second user device, upon receiving the reference to the content, to automatically access and load the content via the network.

17. The machine-implemented method of claim 16, wherein the content is selected from the group consisting of a video file, a document file, an image file, an audio file, a webpage and combinations thereof.

18. The machine-implemented method of claim 16, wherein, the reference to the content comprises instructions to cause each second user device, upon receiving the reference to the content, to access and load the content beginning at the same portion of the content.

19. The machine-implemented method of claim 16, further comprising:
receiving, at the server device, a seek request from the first user device; and
sending to each second user device, in response to receiving the seek request, instructions to cause the second user device to access the content beginning at the same portion that is currently being accessed by the first user device.

20. The machine-implemented method of claim 16, further comprising:
receiving, at the server device, a synchronize request from the first user device; and
sending to the first user device, in response to receiving the synchronize request, instructions to cause the first user device to access the content beginning at the same portion that is currently being accessed by at least one of the second user devices.

21. The machine-implemented method of claim 20, further comprising obtaining state information about the content being accessed by the at least one second user device prior to sending the instructions to cause the first user device to access the content beginning at the same portion that is currently being accessed by at least one of the second user devices.

22. The machine-implemented method of claim 16, further comprising:
receiving, at the server device, a related content request from the first user device; and
sending to the first user device a collection of different content, wherein the collection of different content is selected based on a feature of the referenced content.

23. The machine-implemented method of claim 16, further comprising storing at the server device identification information for each member of the group.

24. The machine-implemented method of claim 23, wherein the identification information comprises individual member identification information and group identification information.

25. The machine-implemented method of claim 16 further comprising:
storing content in a playlist queue accessible by the first user device and the second user devices.

26. The machine-implemented method of claim 16, wherein the group of people corresponds to a first group that is a subset of a second larger group, and wherein the method further comprises:
sending from the server device, over the network, the reference to the content to at least one third user device of a member of the second group.

27. The machine-implemented method of claim 16, wherein the reference to the content comprises information about the identity of the member that initiated the lead to content.

28. The system of claim 1, wherein the group of people corresponds to a first group, and wherein the system, in response to receiving a lead to a second group, sends a reference to the second group to one or more user devices associated with members of the first group, and wherein the lead to the second group is issued by the member of the first group.

29. The system of claim 1, wherein the content comprises a plurality of different content items, and wherein one or more of the user devices concurrently load and access at least some of the different content items in response to receiving the reference to the content.

30. The system of claim 1, wherein the reference to the content comprises a reference to a plurality of different content items.

31. The system of claim 1, wherein at least one of the user devices is configured to broadcast over the network identification information for the group and information about a location of the at least one user device.

32. An on-line system that allows a group of people to interact around common content, the system comprising:
a computer network;
a server system coupled to the computer network; and
a plurality of user devices, each of which is coupled to the computer network and each of which is associated with a respective member of the group,
wherein the server system stores identification information for each member of the group,
wherein, in response to receiving a lead to content initiated by a member of the group, the server system sends a reference comprising a link to the content to the respective user devices of the other members of the group, and wherein the server system causes at least some of the user devices to access and load the content beginning at the same portion of the content upon selection of the link.
